(19) United States
(12) Patent Application Publication
(10) Pub. No.: US 2026/0169216 A1
(43) Pub. Date: Jun. 18, 2026

(54) HOLLOW-CORE FIBERS FEATURING ROTATED ANTI-RESONANT ELEMENTS

(71) Applicant: Relativity Networks, Inc., Winter Park, FL (US)

(72) Inventors: Md Selim HABIB, West Melbourne, FL (US); Rodrigo AMEZCUA CORREA, Orlando, FL (US); Jose Enrique ANTONIO-LOPEZ, Orlando, FL (US); Miguel BANDRES, Oviedo, FL (US)

(21) Appl. No.: 19/415,765

(22) Filed: Dec. 10, 2025

Related U.S. Application Data
(60) Provisional application No. 63/734,029, filed on Dec. 13, 2024.
(60) Provisional application No. 63/743,520, filed on Jan. 9, 2025.
(60) Provisional application No. 63/786,289, filed on Apr. 10, 2025.
(60) Provisional application No. 63/829,472, filed on Jun. 24, 2025.
(60) Provisional application No. 63/829,483, filed on Jun. 24, 2025.
(60) Provisional application No. 63/829,489, filed on Jun. 24, 2025.
(60) Provisional application No. 63/831,544, filed on Jun. 27, 2025.
(60) Provisional application No. 63/859,019, filed on Aug. 6, 2025.
(60) Provisional application No. 63/881,331, filed on Sep. 13, 2025.
(60) Provisional application No. 63/885,111, filed on Sep. 19, 2025.
(60) Provisional application No. 63/888,648, filed on Sep. 26, 2025.
(60) Provisional application No. 63/897,460, filed on Oct. 10, 2025.
(60) Provisional application No. 63/897,545, filed on Oct. 10, 2025.
(60) Provisional application No. 63/897,615, filed on Oct. 11, 2025.
(60) Provisional application No. 63/908,278, filed on Oct. 30, 2025.
(60) Provisional application No. 63/913,432, filed on Nov. 7, 2025.

(51) Int. Cl. G02B 6/02

(52) U.S. Cl. CPC G02B 6/02328

(57) ABSTRACT

An optical fiber including a cladding structure extending along a fiber length providing a hollow interior fiber region is disclosed. The cladding structure includes one or more sets of grouped anti-resonant (AR) elements distributed within the hollow interior fiber region, configured to guide light along the fiber length in a central portion of the interior fiber region. The set of grouped AR elements includes a first AR element disposed on the interior surface of the cladding structure, a support structure disposed on an interior surface of the first AR element, and a second AR element disposed on the support structure. The second AR element is rotated such that a first center line connecting center points of the second AR element and the support structure is offset by a non-zero angle relative to a second center line connecting the centers of the first AR element and the interior fiber region.

### CROSS-REFERENCE TO RELATED APPLICATION

The present application claims the benefit of U.S. Provisional Patent Applications 63/829472 filed on Jun. 24, 2025; 63/743520 filed on Jan. 9, 2025; 63/786289 filed on Apr. 10, 2025; 63/908278 filed on Oct. 30, 2025; 63/829483 filed on Jun. 24, 2025; 63/829489 filed on Jun. 24, 2025; 63/831544 filed on Jun. 27, 2025; 63/859019 filed on Aug. 6, 2025; 63/881331 filed on Sep. 13, 2025; 63/885111 filed on Sep. 19, 2025; 63/734029 filed on Dec. 13, 2024; 63/888648 filed on Sep. 26, 2025; 63/897460 filed Oct. 10, 2025; 63/897615 filed on Oct. 11, 2025; 63/897545 filed on Oct. 10, 2025; and 63/913432 filed on Nov. 7, 2025. All of the above provisional patent applications are hereby incorporated herein by reference in their entirety.

### TECHNICAL FIELD

The present disclosure relates generally to hollow core optical fibers, and more specifically to hollow core optical fibers having anti-resonant elements that are rotated relative to the center of the hollow core.

### BACKGROUND OF THE INVENTION

As the demand for data communication services, Internet, cloud computing, information exchange, etc. has exponentially increased over the past few decades, newer telecom infrastructure is being developed that offers higher transmission capacity, lower loss and lower latency. An example of such a telecom infrastructure includes anti-resonant (AR) hollow-core fibers (HCFs). An AR-HCF offers various benefits over a traditional glass or solid core optical fiber (SMF/MMF) including, but not limited to, a high average and peak power capability, high damage thresholds, low latency, low non-linearities, etc.

An AR-HCF typically includes one or more tubular elements (or “AR elements”) and/or structures having thin walls (thin meaning smaller thickness when compared to the wavelength of the propagating light within the fiber), which enables light to propagate through the elements without significant losses. During the light propagation through an HCF, it is desirable that the fundamental mode of the light signal is allowed to propagate efficiently, while the higher-order modes should be suppressed or attenuated as the higher order modes cause dispersion, mode instability and interference with single-mode performance. Newer AR-HCF structures are being designed that facilitate in suppressing the higher-order modes.

### BRIEF DESCRIPTION OF THE DRAWINGS

Various embodiments of the invention are disclosed in the following detailed description and the accompanying drawings.

FIG. 1A depicts a cross-sectional view of an anti-resonant (AR) hollow-core fiber (HCF) with non-rotated AR elements.

FIG. 1B depicts a cross-sectional view of a first embodiment of an AR-HCF, in accordance with one or more embodiments of the present disclosure.

FIG. 1C depicts a cross-sectional view of a second embodiment of an AR-HCF, in accordance with one or more embodiments of the present disclosure.

FIG. 1D depicts a cross-sectional view of a third embodiment of an AR-HCF, in accordance with one or more embodiments of the present disclosure.

FIG. 1E depicts a cross-sectional view of a fourth embodiment of an AR-HCF, in accordance with one or more embodiments of the present disclosure.

FIG. 1F depicts a cross-sectional view of a fifth embodiment of an AR-HCF, in accordance with one or more embodiments of the present disclosure.

FIG. 2A depicts a cross-sectional view of another AR-HCF with non-rotated AR elements.

FIG. 2B depicts a cross-sectional view of a sixth embodiment of an AR-HCF, in accordance with one or more embodiments of the present disclosure.

FIG. 2C depicts an exemplary first graph between wavelength of propagating light and losses in fundamental mode of signal transmission, in accordance with one or more embodiments of the present disclosure.

FIG. 2D depicts an exemplary second graph between wavelength of propagating light and losses in higher order modes of signal transmission, in accordance with one or more embodiments of the present disclosure.

FIG. 2E depicts an exemplary third graph between wavelength of propagating light and losses in fundamental mode of signal transmission, in accordance with one or more embodiments of the present disclosure.

FIG. 2F depicts an exemplary fourth graph between wavelength of propagating light and losses in higher order modes of signal transmission, in accordance with one or more embodiments of the present disclosure.

FIG. 2G depicts an exemplary fifth graph between wavelength of propagating light and losses in fundamental mode of signal transmission, in accordance with one or more embodiments of the present disclosure.

FIG. 2H depicts an exemplary sixth graph between wavelength of propagating light and losses in higher order modes of signal transmission, in accordance with one or more embodiments of the present disclosure.

FIG. 2I depicts an exemplary seventh graph between wavelength of propagating light and losses in fundamental mode of signal transmission, in accordance with one or more embodiments of the present disclosure.

FIG. 2J depicts an exemplary eighth graph between wavelength of propagating light and losses in fundamental mode of signal transmission, in accordance with one or more embodiments of the present disclosure.

FIG. 2K depicts an exemplary ninth graph between wavelength of propagating light and losses in fundamental mode of signal transmission, in accordance with one or more embodiments of the present disclosure.

FIG. 2L depicts an exemplary tenth graph between wavelength of propagating light and losses in fundamental mode of signal transmission, in accordance with one or more embodiments of the present disclosure.

FIG. 2M depicts a cross-sectional view of a seventh embodiment of an AR-HCF, in accordance with one or more embodiments of the present disclosure.

FIG. 2N depicts a cross-sectional view of an eighth embodiment of an AR-HCF, in accordance with one or more embodiments of the present disclosure.

FIG. 2O depicts a cross-sectional view of a ninth embodiment of an AR-HCF, in accordance with one or more embodiments of the present disclosure.

FIG. 2P depicts a cross-sectional view of a tenth embodiment of an AR-HCF, in accordance with one or more embodiments of the present disclosure.

FIG. 2Q depicts a cross-sectional view of an eleventh embodiment of an AR-HCF, in accordance with one or more embodiments of the present disclosure.

FIG. 2R depicts a cross-sectional view of a twelfth embodiment of an AR-HCF, in accordance with one or more embodiments of the present disclosure.

FIG. 2S depicts a cross-sectional view of a thirteenth embodiment of an AR-HCF, in accordance with one or more embodiments of the present disclosure.

FIG. 2T depicts a cross-sectional view of a fourteenth embodiment of an AR-HCF, in accordance with one or more embodiments of the present disclosure.

FIG. 2U depicts a cross-sectional view of a fifteenth embodiment of an AR-HCF, in accordance with one or more embodiments of the present disclosure.

FIG. 2V depicts a cross-sectional view of a sixteenth embodiment of an AR-HCF, in accordance with one or more embodiments of the present disclosure.

FIG. 2W depicts a cross-sectional view of a seventeenth embodiment of an AR-HCF, in accordance with one or more embodiments of the present disclosure.

FIG. 2X depicts a cross-sectional view of an eighteenth embodiment of an AR-HCF, in accordance with one or more embodiments of the present disclosure.

FIG. 2Y depicts a cross-sectional view of a nineteenth embodiment of an AR-HCF, in accordance with one or more embodiments of the present disclosure.

FIG. 3 depicts a cross-sectional view of a twentieth embodiment of an AR-HCF, in accordance with one or more embodiments of the present disclosure.

FIG. 4 depicts a cross-sectional view of a twenty first embodiment of an AR-HCF, in accordance with one or more embodiments of the present disclosure.

FIG. 5A depicts a cross-sectional view of a twenty second embodiment of an AR-HCF, in accordance with one or more embodiments of the present disclosure.

FIG. 5B depicts a cross-sectional view of a twenty third embodiment of an AR-HCF, in accordance with one or more embodiments of the present disclosure.

FIG. 6A depicts a cross-sectional view of a twenty fourth embodiment of an AR-HCF, in accordance with one or more embodiments of the present disclosure.

FIG. 6B depicts a cross-sectional view of a twenty fifth embodiment of an AR-HCF, in accordance with one or more embodiments of the present disclosure.

FIG. 6C depicts a cross-sectional view of a twenty sixth embodiment of an AR-HCF, in accordance with one or more embodiments of the present disclosure.

FIG. 6D depicts a cross-sectional view of a twenty seventh embodiment of an AR-HCF, in accordance with one or more embodiments of the present disclosure.

FIG. 7 depicts a cross-sectional view of a twenty eighth embodiment of an AR-HCF, in accordance with one or more embodiments of the present disclosure.

FIG. 8A depicts a cross-sectional view of yet another AR-HCF with non-rotated AR elements.

FIG. 8B depicts a cross-sectional view of a twenty ninth embodiment of an AR-HCF, in accordance with one or more embodiments of the present disclosure.

FIG. 9 is a flow diagram of a method to make an AR-HCF in accordance with one or more embodiments of the present disclosure.

### SUMMARY

An optical fiber is disclosed in accordance with one or more illustrative embodiments. In some embodiments, the optical fiber may include a cladding structure extending along a fiber length providing a hollow interior fiber region. The optical fiber may further include a first anti-resonant (AR) element distributed within the hollow interior fiber region. The optical fiber may additionally include a support structure located in the hollow interior fiber region. The first AR element may be disposed on an interior surface of the cladding structure via the support structure. Further, in certain embodiments, the first AR element may be rotated in the hollow interior fiber region such that a first (imaginary) center line connecting the support structure and a center point of the first AR element is offset by a non-zero angle relative to a second (imaginary) center line connecting the support structure and a center point of the hollow interior fiber region.

The first AR element may be configured to guide light along the fiber length in a central portion of the hollow interior fiber region based on optical anti-resonance.

In some embodiments, the optical fiber may further include a second AR element that may enclose the first AR element. Stated another way, the first AR element may be located within an interior region of the second AR element bounded at least in part by walls of the second AR element. In certain embodiments, the second AR element may be positioned on the interior surface of the cladding structure such that a portion of the walls of the second AR element contacts the interior surface of the cladding structure. Further, in this case, the support structure may be positioned on the portion of the walls of the second AR element that contacts the interior surface of the cladding structure.

In the embodiment described above, a width or diameter of the second AR element may be greater than a width or diameter of the first AR element. Further, a thickness of the walls of the second AR element may be equivalent to or different from a thickness of walls of the first AR element.

In additional embodiments, the optical fiber may include a support slab formed as at least a portion of the walls of the second AR element. In this embodiment, the walls of the second AR element may have a non-uniform wall thickness profile in a cross-sectional plane defining a shape of the support slab. Further, in some embodiments, the support slab may have a non-uniform thickness profile.

In the embodiment described above, the second AR element may be positioned on the interior surface of the cladding structure such that a portion of the support slab contacts the interior surface of the cladding structure. Further, in this case, the support structure may be positioned on the support slab.

In an alternative embodiment, the second AR element may be located within an interior region of the first AR element bounded at least in part by walls of the first AR element. In this case, a width or diameter of the second AR element may be less than a width or diameter of the first AR element.

In some embodiments, the first AR element and/or the second AR element may have a cross-sectional shape as one of: a circle, an ellipse, a truncated circle, a truncated ellipse, a triangle, a square, a pentagon, a hexagon, a heptagon, or an octagon.

Further, in certain embodiments, the non-zero angle described above may be in a range of 1 to 15 degrees. In an exemplary embodiment, the non-zero angle is 1 or 2 degrees.

In accordance with further embodiments of the present disclosure, a method for making an optical fiber is disclosed. The method may include providing a cladding structure extending along a fiber length providing a hollow interior fiber region. The method may further include providing an anti-resonant (AR) element distributed within the hollow interior fiber region. The method may additionally include providing a support structure located in the hollow interior fiber region. The AR element may be disposed on an interior surface of the cladding structure via the support structure. Further, the AR element may be rotated in the hollow interior fiber region such that a first (imaginary) center line connecting the support structure and a center point of the AR element is offset by a non-zero angle relative to a second (imaginary) center line connecting the support structure and a center point of the hollow interior fiber region.

### DETAILED DESCRIPTION

The invention can be implemented in numerous ways, including as a process; an apparatus; a system; a combination of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘process’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of the present disclosure are directed to an anti-resonant (AR) hollow-core fiber (HCF). AR-HCFs offer significant potential to replace solid-core standard silica fibers across a wide range of applications, particularly in communications. These fibers exhibit weak electromagnetic field overlap with the glass material, resulting in lower nonlinearity, higher damage thresholds, broader transmission windows, reduced Rayleigh scattering, and faster propagation speeds (lower latency) compared to solid-core fibers.

In AR hollow core fibers, light confinement within the core is achieved by glass membranes of uniform thickness surrounding the core, which confine light in air. These thin glass membranes effectively repel the light field, resulting in negligible surface scattering loss. However, to minimize confinement loss, multiple layers of these glass membranes are required to form efficient AR elements that expel light. In the present disclosure, AR elements are referred to as structures of glass membranes that provide confinement.

It may be appreciated that in an AR-HCF, light or optical signal is guided in the hollow core as a result of anti-resonant properties of thin-walled structures (e.g., AR elements) extending along the length of the fiber. Since the light or optical signal is guided in a “hollow” core in an AR-HCF, as opposed to a solid/glass core in the case of a standard solid/glass core fiber, the speed of travel of optical signal (and hence the speed of signal transmission) in an AR-HCF is considerably greater than the speed of signal transmission in a solid/glass core optical. Specifically, since the optical signal travels through the hollow core in an AR-HCF, which is essentially vacuum having an index of refraction (“n”) as 1, the optical signal travels through the AR-HCF at a speed that is equivalent to (or substantially equivalent to) the speed of light (as speed of signal in the medium=speed of light (“c”)/n). This is in contrast to the speed of optical signal in a solid/glass core fiber, which typically has an index of refraction in a range of 1.4-1.5, and hence offers a lower speed of transmission of the optical signal.

Furthermore, AR-HCFs offer various benefits over standard solid/glass core fibers including, but not limited to, high average and peak power capability, high damage thresholds, low latency, low non-linearities, etc. Considering these advantages and the greater speed of signal transmission, many telecom service providers are adopting AR-HCFs for signal transmission, to provide enhanced services to their customers.

It is known that when light is transmitted through the hollow core of the AR-HCF, higher order modes of light transmission are formed, which are undesirable because they cause dispersion, mode instability, and interference with single-mode performance. During light transmission, it is preferred that only the fundamental mode (LP01) of light transmission should exist, and the higher order modes should be suppressed or attenuated. Stated another way, it is desirable that losses in the fundamental mode of light transmission should be as low as possible, and the losses in the higher order modes should be large (to cause them to radiate out into the cladding). A person ordinarily skilled in the art may appreciate that when light travels in the fundamental mode, the associated electric field is most intense at the center of the core and gradually fades outwards. The light propagates with least dispersion and loss in the fundamental mode. On the other hand, the electric fields in higher order modes exhibit more complex patterns, with multiple lobes or rings of intensity. The light interacts more with the core-cladding boundary in the higher order modes, making the light signals more prone to loss and dispersion.

In an ideal scenario, the AR-HCF should enable the fundamental mode to propagate efficiently, and suppress/attenuate most (if not all) of the higher order modes. A person ordinarily skilled in the art may appreciate that suppressing or attenuating the higher order modes is commonly referred to as “frustrating” the higher order modes, which means making it difficult or impossible for the higher-order modes to propagate effectively through the hollow core fiber. Frustrating the higher order modes and enabling the fundamental mode to propagate efficiently in an HCF is important to ensure beam quality and signal stability, which is crucial for low-loss and high-power signal transmission.

The present disclosure proposes to engineer or modify the fiber structure to frustrate the higher order modes. Specifically, the present disclosure describes a novel design of an AR-HCF, which causes considerable frustration of the higher order modes, while at the same time ensures that the fundamental mode propagates efficiently without any significant loss. The AR-HCF, as proposed in the present disclosure, may include one or more cladding structures providing a hollow interior fiber region extending a length of the fiber (e.g., along a fiber length) and multiple AR elements distributed around or in the interior fiber region, which forms a hollow core surrounded by AR elements. Further, such an AR-HCF may have any suitable size. In some embodiments, the hollow core size of an AR-HCF fiber is between 5× and 100× the guided wavelength. For example, the hollow core size of an AR-HCF fiber may be, but is not limited to, 5×, 10×, 20×, 30×, 50×, or 100× the guided wavelength.

The AR elements may include walled structures with walls that extend along the fiber length. In some aspects, the walls of the AR elements and/or the distribution of the AR elements may provide guiding of light in a central hollow interior region of the AR-HCF through anti-resonant optical phenomena. Further, some of the AR elements may be nested. As an illustration, one AR element may be located within an interior region bounded at least in part by walls of another AR element.

In some embodiments, the AR elements may have circular cross-section. In other embodiments, the AR elements may be non-circular in cross section. For example, the AR elements may be parabolic, elliptical, a truncated circle, a truncated ellipse, a triangle, a square, a pentagon, a hexagon, a heptagon, an octagon, or have other cross sections (e.g., may have a cross-sectional shape of a snowman or shaped as figure “8”). Furthermore, nested AR elements may or may not lie on an imaginary line extending from the center of the AR-HCF. For example, an inner AR element and an outer AR element (e.g., in a nested arrangement) may or may not lie on the same imaginary line extending from the center of the AR-HCF.

In some aspects, one or more AR elements of the AR-HCF, as proposed in the present disclosure, may be positioned on an interior surface of the cladding structure via a support structure. In one exemplary embodiment, the support structure may be part of the walls of the AR element, and may contact the interior surface of the cladding structure to position the AR element on the cladding structure. In an alternative embodiment, the support structure may not be part of the walls of the AR element but may be a structure external to the AR element, which may touch the exterior surface of the walls of the AR element and the interior surface of the cladding structure. In this embodiment as well, the support structure may position the AR element on the cladding structure.

The support structure described above may or may not provide AR properties directly. For example, a support structure may be relatively thick and may thus not operate as an anti-resonant element itself. However, such a support structure may position one or more AR elements, or portions thereof, within the AR-HCF to provide desired performance characteristics. More broadly, it is recognized herein that various aspects of the performance of an AR-HCF such as, but not limited to, the confinement of light within the interior fiber region may generally depend on the complete distribution of all associated elements of the AR-HCF including any support structures. A support structure may generally have any shape suitable for positioning an AR element within an AR-HCF. Further, a support structure may be located at any location within an AR-HCF.

In the AR-HCF proposed in the present disclosure, the AR element is “rotated” in the hollow interior fiber region of the AR-HCF such that an imaginary center line (or “first center line”) connecting the support structure and a center point of the AR element is offset by a non-zero angle relative to an imaginary center line (or “second center line”) connecting the support structure and a center point of the hollow interior fiber region. The non-zero angle may be in a range of 1 to 15 degrees. In a preferred embodiment, the non-zero angle is between 1 and 5 degrees, e.g., 1 or 2 degrees.

It has been observed that when the AR element is rotated relative to the second center line as described above, the frustration of the higher order modes is greatly enhanced, leading to their losses. At the same time, such rotation does not adversely affect the fundamental mode of light transmission. Consequently, it has been observed that in comparison to a “standard” AR-HCF in which the center point of the AR element is aligned with the center point of the hollow interior fiber region, the AR-HCF with the rotated AR element, as proposed in the present disclosure, provides enhanced frustration of the higher order modes and equivalent losses in the fundamental mode for a wide wavelength range of signal transmission.

In some aspects, the rotation of the AR element, as described above, is performed during the manufacturing process of the AR-HCF. Specifically, the rotation is performed while the preform is being made or when the preform is being drawn from the draw tower.

Another structure is proposed for an AR-HCF that includes one or more nested AR elements (e.g., when a first AR element is located within an interior region of a second AR element bounded at least in part by walls of the second AR element). In this case, a portion of the walls of the second AR element may be positioned on the interior surface of the cladding structure, and the support structure described above may position the first AR element on the portion of the walls of the second AR element that is positioned on the interior surface of the cladding structure. Similar to the embodiment described above, in this case as well, the first AR element may be rotated in the hollow interior fiber region of the AR-HCF such that the imaginary center line connecting the support structure and a center point of the first AR element is offset by a non-zero angle relative to the imaginary center line connecting the support structure and the center point of the hollow interior fiber region.

In further aspects, a design of a nested AR-HCF is proposed in which the AR-HCF includes a support slab formed as a portion of the walls of the second AR element. In this case, the walls of the second AR element may have a non-uniform wall thickness profile in a cross-sectional plane defining a shape of the support slab. In this design, a portion of the support slab contacts the interior surface of the cladding structure, thereby positioning the second AR element on the interior surface of the cladding structure. Further, in this case, the support structure may be positioned on the support slab, which enables the first AR element to be positioned on the support slab. Similar to the embodiment described above, in this case as well, the first AR element may be rotated in the hollow interior fiber region of the AR-HCF in a similar manner.

Similar to the support structure described above, the support slab may or may not provide AR properties directly. For example, the support slab may be relatively thick and may thus not operate as an anti-resonant element itself. However, such a support slab may position one or more AR elements, or portions thereof, within the AR-HCF to provide desired performance characteristics. More broadly, it is recognized herein that various aspects of the performance of an AR-HCF such as, but not limited to, the confinement of light within the interior fiber region may generally depend on the complete distribution of all associated elements of the AR-HCF including any support structures and/or support slabs.

A support slab may generally have any shape suitable for positioning an AR element within an AR-HCF. Further, a support slab may be located at any location within an AR-HCF. In some embodiments, a support slab extends from one AR element to another. For example, a support slab may extend from or otherwise be a part of one or more AR elements. As an illustration, an AR element may have walls with a non-uniform thickness profile (e.g., as measured in a cross-sectional plane orthogonal to a direction along the fiber length). In this configuration, a support slab may be formed as a relatively thick portion of the walls of an AR element. It is contemplated herein that such a configuration may be suitable for, but not limited to, positioning a nested AR element (e.g., via the support structure described above) within an interior region of another AR element.

In some embodiments, a support slab may be located between the cladding structure and one or more AR elements. For example, such a support slab may be formed as a rod, a pedestal, a tube, a slab with a rectangular cross section, a slab with a circular cross section, a slab with a cross section of less than a whole circle (such as half or a part of a circle), or a combination thereof. Further, such a support slab may be solid, porous, or hollow.

It is contemplated herein that nomenclature used herein to separately describe AR elements, support structures and support slabs as separate elements is merely illustrative and should not be interpreted as limiting the scope of the present disclosure. For example, the various elements of a fabricated AR-HCF (e.g., AR elements, cladding structures, support structures, support slabs, and the like) may be fused together into a continuous fiber structure with a designed cross-sectional profile. In this way, the use of separate nomenclature herein to describe different aspects of the cross-sectional profile is merely for convenience of description. For example, some descriptions herein describe a support slab or support structure as extending from an AR element. However, such a support structure or support slab may be indistinguishable from the AR element such that it may also be accurate to describe the support structure or support slab as being integrated into and forming a part of the AR element. For example, a support structure or a support slab may be integrated with an AR element in such a way that the AR element and the support structure or support slab are one cohesive element.

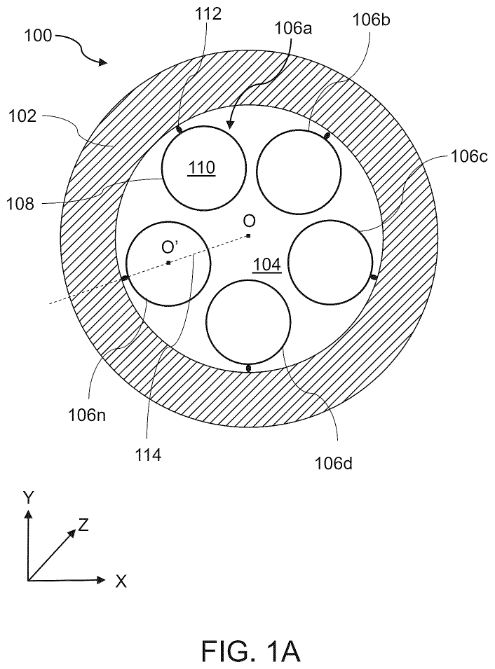

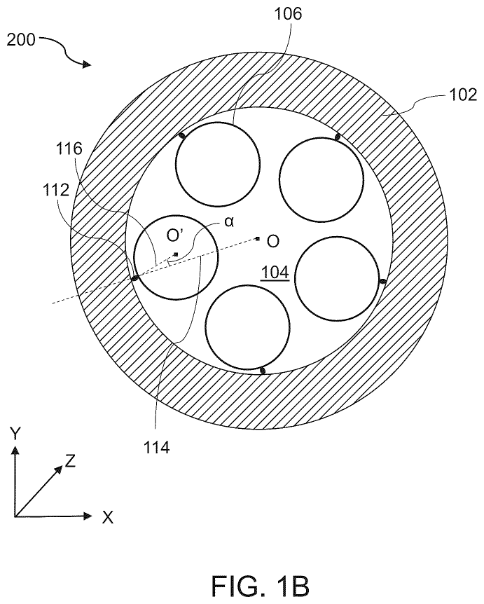

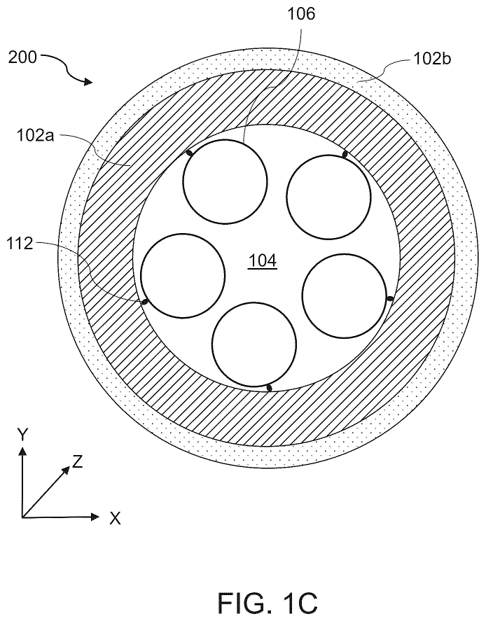

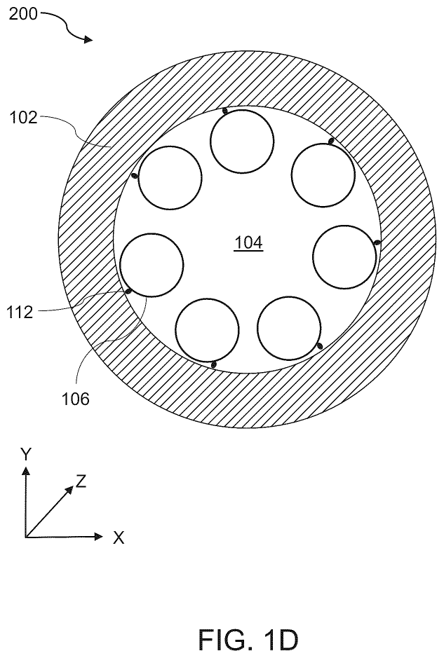

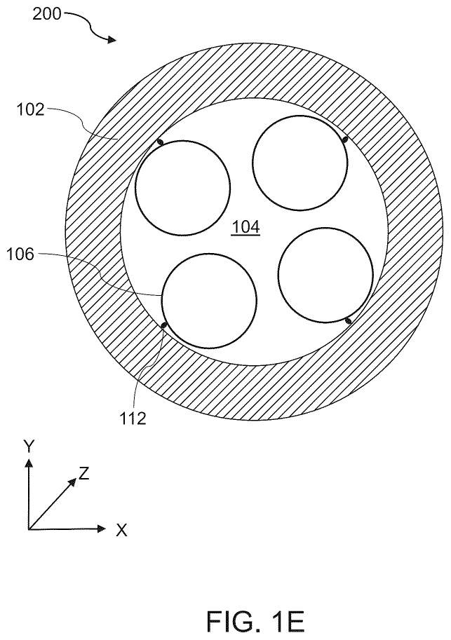

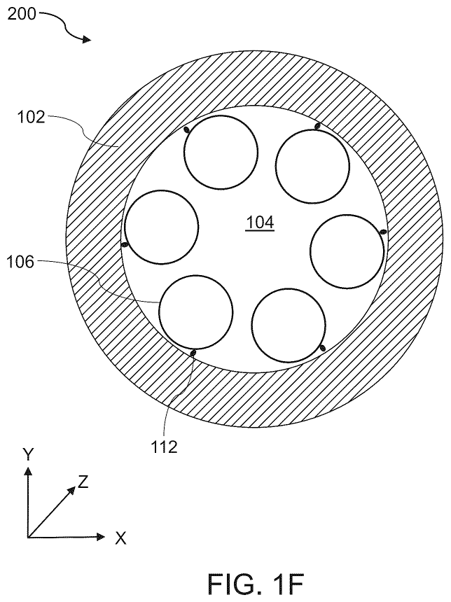

Referring now to FIGS. 1A-8B, a plurality of designs of AR-HCFs is described in greater detail, in accordance with one or more embodiments of the present disclosure.

FIG. 1A depicts a cross-sectional view of an anti-resonant (AR) hollow-core fiber (HCF) 100 with non-rotated AR elements. In particular, FIG. 1A depicts a cross-section of the AR-HCF 100 in an X-Y plane, where a length of the AR-HCF 100 extends along the Z direction (e.g., a direction along the fiber length). It is to be understood that the AR-HCF 100 may generally be flexible and/or bend such that the fiber length need not extend along a straight line. In this way, the cross-sectional view depicted in FIG. 1A may correspond to a plane orthogonal to the fiber length at any selected location.

FIG. 1A will be described in conjunction with FIGS. 1B-1F, which depict different embodiments of an AR-HCF 200 that is similar to the AR-HCF 100; however, the AR-HCF 200 has “rotated” AR elements that significantly frustrate the higher order modes, as briefly described above and described in detail later in the description below.

In some embodiments, the AR-HCF 100 may include one or more cladding structures 102 extending along a fiber length providing a hollow interior fiber region 104 (or hollow interior region 104). For example, FIG. 1A depicts the AR-HCF 100 with a single cladding structure 102 formed as a circular tube. The present disclosure is not limited to such a design of the AR-HCF. For example, FIG. 1C depicts the AR-HCF 200 in which the AR-HCF 200 has two cladding structures 102a, 102b. The cladding structures 102a, 102b may be concentric, and the cladding structure 102a may have a lesser diameter than the diameter of the cladding structure 102b.

In certain embodiments, the AR-HCF 100, 200 may include more than two cladding structures as well, without departing from the scope of the present disclosure. In other embodiments, the AR-HCF 100 may include additional AR elements nested within the depicted AR elements. Accordingly, the illustration of the AR-HCF 100, 200 depicted in FIGS. 1A and 1C should not be construed as limiting.

The AR-HCF 100 may further include a plurality of AR elements 106a, 106b, 106c, 106d, 106n (shown in FIG. 1A, collectively referred to as “first AR elements” or AR elements 106) distributed within the hollow interior region 104 provided by the cladding structure 102. The AR elements 106 may be configured to guide light along the fiber length in a central portion of the hollow interior region 104 based on optical anti-resonance. The AR-HCF 100 may generally have any number of AR elements 106, and the AR elements 106 may be evenly or unevenly distributed around a perimeter of the hollow interior region 104. For example, FIG. 1A depicts a non-limiting configuration of an AR-HCF 100 with five AR elements 106 uniformly distributed around a perimeter of the hollow interior region 104 formed by the cladding structure 102. Further, in the exemplary embodiment depicted in FIG. 1A, the AR elements 106 do not touch adjacent AR elements 106. However, the present disclosure is not limited to such an arrangement. The AR-HCF, as proposed in the present disclosure, may include more or less than five AR elements 106, and each AR element 106 may or may not touch adjacent AR elements, as described later in the description below.

In some aspects, each AR element 106 may be formed as a walled structure with one or more walls 108 extending along the fiber length (e.g., along the Z direction in the figures). The walls 108 may be characterized by a thickness (or a thickness profile) in a cross-sectional plane (e.g., the X-Y plane in FIG. 1A). Further, the thickness of any of the walls 108, or portions thereof, may be selected to provide anti-resonant properties to confine and guide light through a central portion of the hollow interior region 104. In this way, at least some of the walls 108, or portions thereof, may provide confinement of light through anti-resonant phenomena.

In some aspects, the thickness of the walls 108 (and/or their refractive index) is selected/designed to provide anti-resonant properties for at least some wavelengths of interest. The walls 108 of all the AR elements 106 may have the same thicknesses (as shown in FIG. 1A), or may have different thicknesses. Further, the AR elements 106 may have the same cross-sectional structures (as shown in FIG. 1A) and/or dimensions (e.g., width or diameter), or may have different structures and/or dimensions. Each AR element 106 may generally have any cross-sectional shape including, but not limited to, a circle (as shown in FIG. 1A), an ellipse, a truncated circle, a truncated ellipse, a triangle, a square, a pentagon, a hexagon, a heptagon, an octagon, or the like.

In some embodiments, the walls 108 of each AR element 106 may be arranged to provide an interior region 110 (e.g., an interior cavity). In this way, the interior region 110 may be at least partially bounded by the walls 108 of at least one AR element 106. The interior region 110 may be empty (as shown in FIG. 1A), or may include one or more additional AR elements and/or support slabs, as described later in the description below.

The hollow interior region 104, as well as any interior cavities of other structures (e.g., the AR elements 106, the cladding structures 102, or the like) may be under vacuum or filled with any gas (e.g., ambient air, nitrogen, argon, or any selected composition). Furthermore, the various components of the AR-HCF 100 including, but not limited to, the AR elements 106 (e.g., the walls 108) and/or the cladding structures 102 may be formed from any suitable material such as, but not limited to, a glass or a polymer. One or more AR elements 106 may be formed from a different material than other AR elements 106. As an example, any such components of the AR-HCF 100 may be formed from silica glass, doped silica glass, chalcogenide glass, fluoride glass, or the like. Further, any such components may be un-doped or doped with one or more dopants. Additionally, the AR-HCF 100 may be formed from a single material or may have different components formed from different materials. Furthermore, in certain embodiments, the index of refraction of one or more AR elements 106 may have a different index of refraction from other AR elements 106.

The AR-HCF 100 may further include support structures 112 that may be located in the hollow interior region 104. The AR element 106 may be disposed or positioned on an interior surface of the cladding structure 102 via the support structure 112, as shown in FIG. 1A. Stated another way, the support structure 112 may position the AR element 106 on the interior surface of the cladding structure 102.

In some aspects, the support structure 112 may be part of the walls 108 of the AR element 106, and may contact the interior surface of the cladding structure 102 to position the AR element 106 on the cladding structure 102. In an alternative aspect, the support structure 112 may not be part of the walls 108 of the AR element 106 but may be a structure external to the AR element 106, which may touch the exterior surface of the walls 108 of the AR element 106 and the interior surface of the cladding structure 102. In this aspect as well, the support structure 112 may position the AR element 106 on the cladding structure 102.

The support structure 112 may have any shape and/or dimensions, which may enable the support structure 112 to robustly and securely position the AR element 106 on the cladding structure 102. For example, the support structure 112 may be shaped as an elongated rod that extends through/along the fiber length (e.g., in the Z-axis). In cross section, the support structure 112 (and other support structures described herein) may be circular, elliptical, rectangular, a wedge, or other shape. Further, the support structure 112 may be solid, porous, or hollow, and may be made of the same or different material as the walls 108 of the AR element 106 or the cladding structure 102. Furthermore, as described above, the support structure 112 may or may not provide AR properties directly.

As shown in FIG. 1A, in the AR-HCF 100, each AR element 106 is “aligned” with a center point “O” of the hollow interior region 104, such that the support structure 112, the center point “O” and a center point “O′” of the AR element 106 are all located on an imaginary center line 114 that connects the support structure 112 and the center point “O”. While this structure of the AR-HCF 100 does facilitate in frustrating the higher order modes to some extent, it has been observed that if the AR element 106 is “rotated” by a small (non-zero) angle about the support structure 112 relative to the imaginary center line 114, the higher order modes are frustrated/attenuated/suppressed to a greater extent, thereby considerably enhancing beam quality and signal stability. Example designs of an AR-HCF with “rotated” AR elements 106 are depicted in FIGS. 1B-1F, 2B, 2M-2W, 2Y-7, 8B, and described below.

FIG. 1B depicts an AR-HCF 200 which is similar to the AR-HCF 100 described above, however, in the AR-HCF 200, the AR element 106 is rotated in the hollow interior region 104 such that an imaginary center line 116 connecting the support structure 112 and the center point “O′” of the AR element 106 is offset by a non-zero angle “α” relative to the imaginary center line 114 connecting the support structure 112 and the center point “O” of the hollow interior region 104. The angle “α” may be in a range of 1 to 15 degrees. In an exemplary aspect, the angle “α” is in a range of 1 to 5 degrees, e.g., 1 or 2 degrees. In some aspects, the AR element 106 may be rotated while the preform is being made or when the preform is being drawn from the draw tower.

FIG. 1B depicts an embodiment where all the AR elements 106 are rotated in a clockwise direction by the angle “α”. However, such a depiction should not be construed as limiting. In other embodiments, all the AR elements 106 may be rotated in a counterclockwise direction, without departing from the scope of the present disclosure. In yet another embodiment, one or more AR elements 106 may be rotated in a clockwise direction, while the remaining AR elements 106 may be rotated in a counterclockwise direction (i.e., the rotation may be random and may not follow a fixed pattern).

Such a “rotated” arrangement of the AR elements 106 relative to the imaginary center line 114 significantly frustrates the higher order modes of signal transmission, while at the same time ensures that the losses in the fundamental mode are substantially equivalent to the losses in the fundamental mode experienced in the “standard” AR-HCF 100 with non-rotated AR elements 106. Stated another way, the AR-HCF 200 considerably enhances the beam quality and signal stability by increasing the losses of the higher order modes, but ensures that the losses associated with the fundamental mode are minimal.

Another embodiment of the AR-HCF 200 is depicted in FIG. 1C, which shows the AR-HCF 200 as having two cladding structures 102a, 102b, as described above.

Although the embodiments of the AR-HCF 200 depicted in FIGS. 1B and 1C show five AR elements 106 distributed within the hollow interior region 104, the present disclosure is not limited to this count of AR elements 106. In additional aspects, the AR-HCF 200 may include more or less than five AR elements 106, as described below.

FIG. 1D depicts an embodiment of the AR-HCF 200 that has seven AR elements 106 distributed within the hollow interior region 104. The AR elements 106 depicted in FIG. 1D may be similar to the AR elements 106 depicted in FIG. 1B, however, the AR elements 106 depicted in FIG. 1D may have smaller diameters. Further, in this embodiment also, the AR elements 106 may be rotated (in the clockwise or counterclockwise direction) about the support structure 112 relative to the imaginary center line 114 in the similar manner as described above, to significantly frustrate the higher order modes.

FIG. 1E depicts an embodiment of the AR-HCF 200 that has four AR elements 106 distributed within the hollow interior region 104. The AR elements 106 depicted in FIG. 1E may be similar to the AR elements 106 depicted in FIG. 1B, however, the AR elements 106 depicted in FIG. 1E may have larger diameters. Further, in this embodiment also, the AR elements 106 may be rotated (in the clockwise or counterclockwise direction) about the support structure 112 relative to the imaginary center line 114 in the similar manner as described above, to significantly frustrate the higher order modes.

FIG. 1F depicts an embodiment of the AR-HCF 200 that has six AR elements 106 distributed within the hollow interior region 104. The AR elements 106 depicted in FIG. 1F may be similar to the AR elements 106 depicted in FIG. 1B, however, the AR elements 106 depicted in FIG. 1F may have smaller diameters. Further, in this embodiment also, the AR elements 106 may be rotated (in the clockwise or counterclockwise direction) about the support structure 112 relative to the imaginary center line 114 in the similar manner as described above, to significantly frustrate the higher order modes.

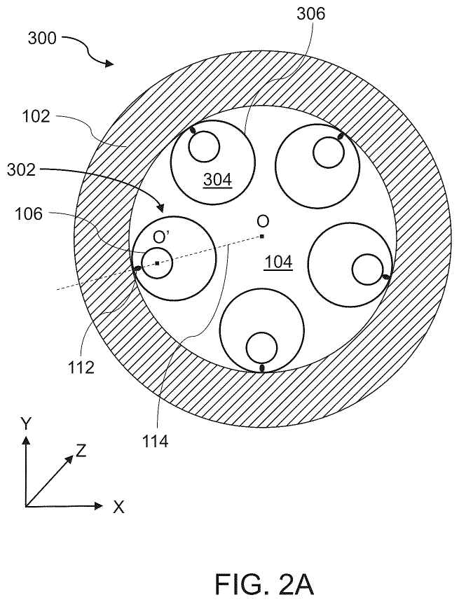

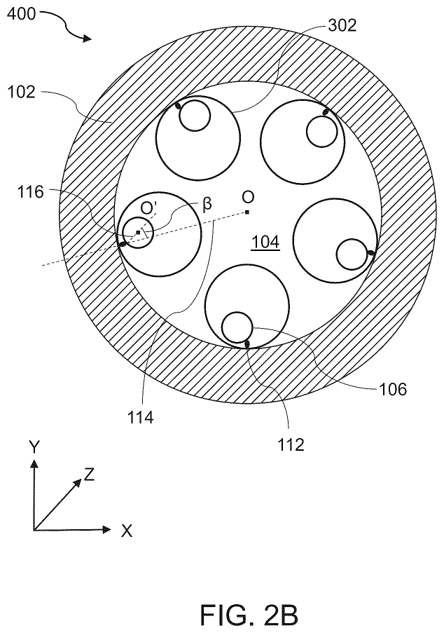

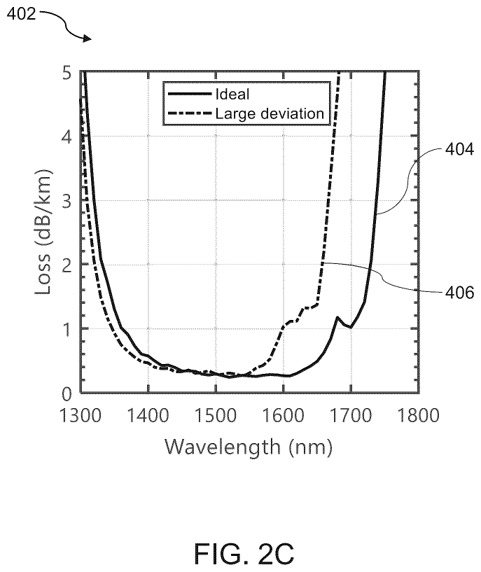

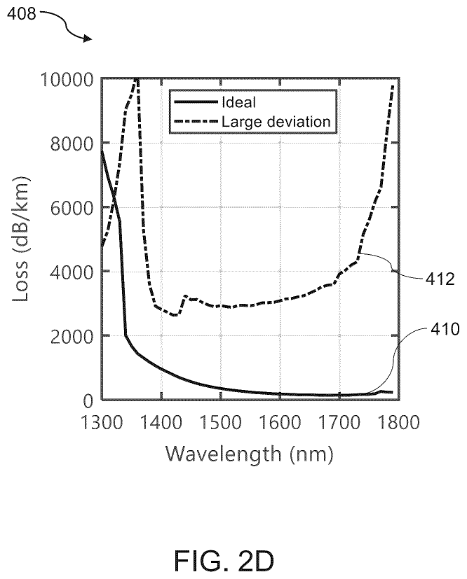

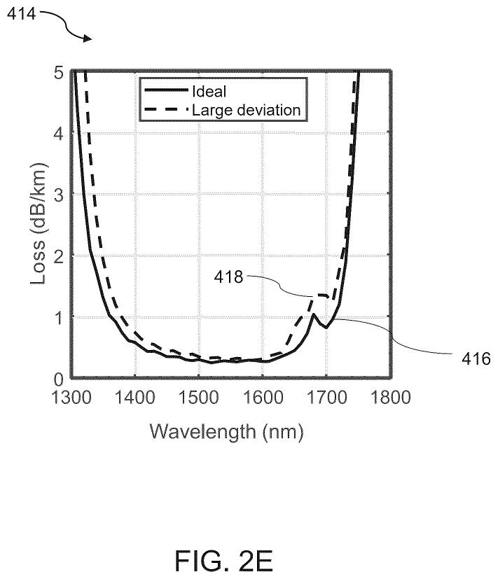

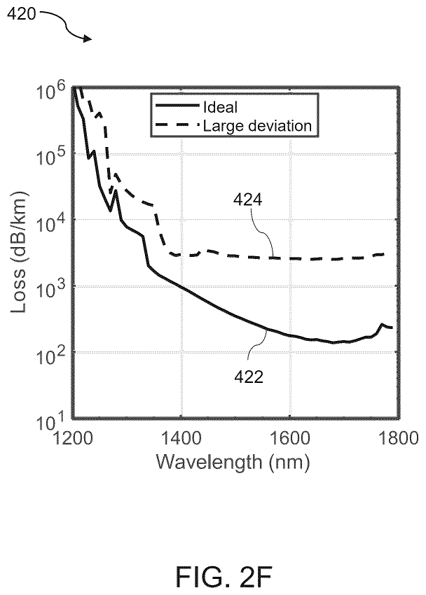

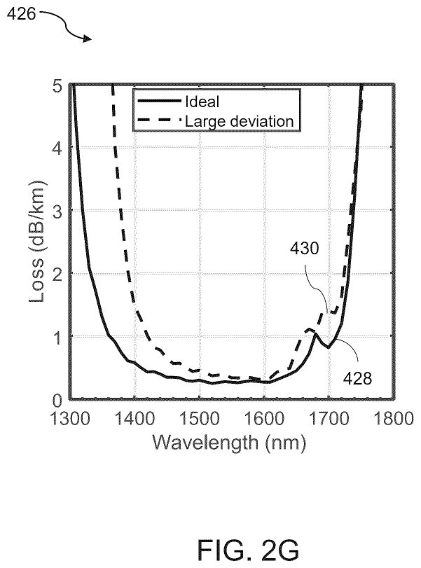

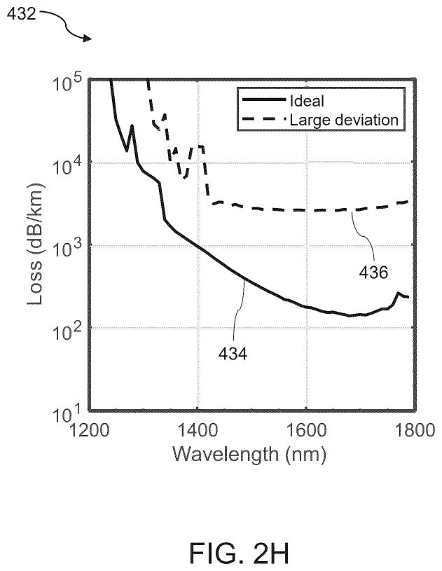

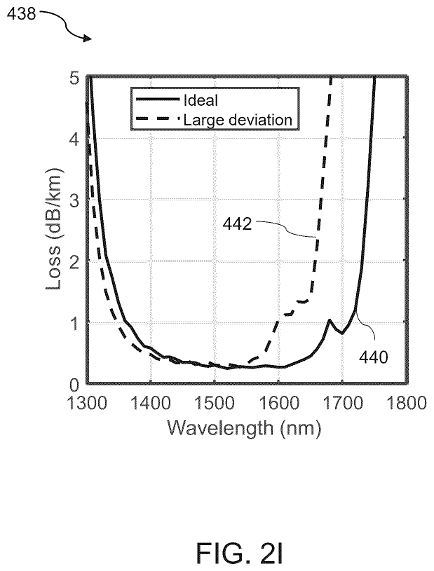

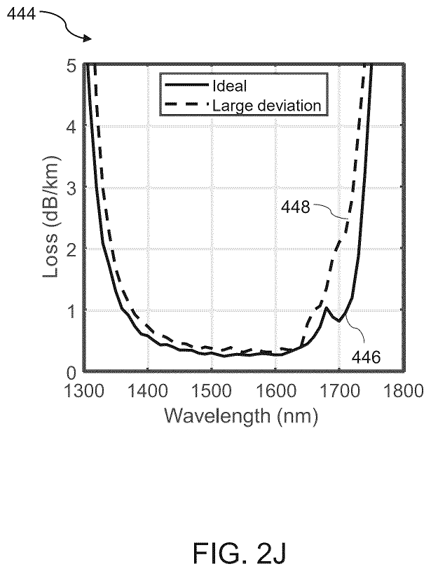

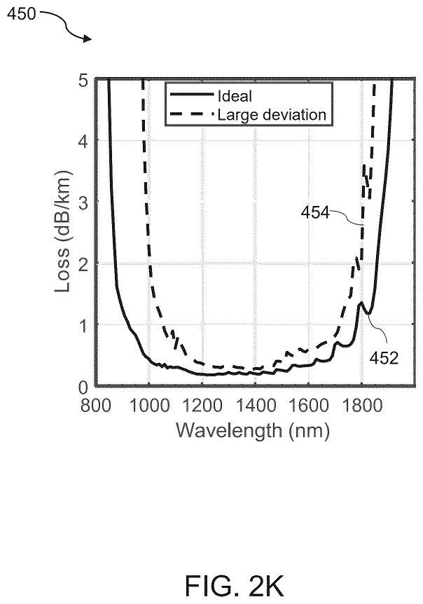

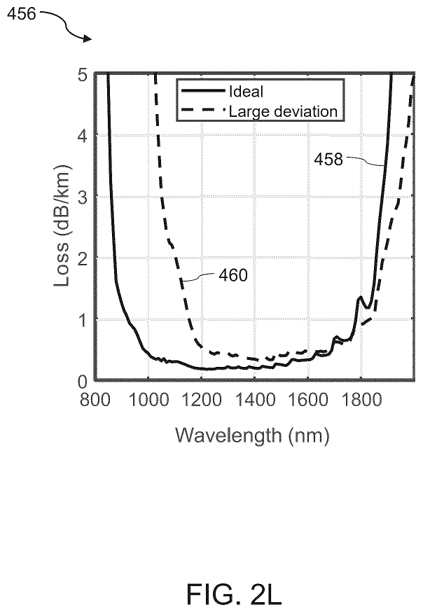

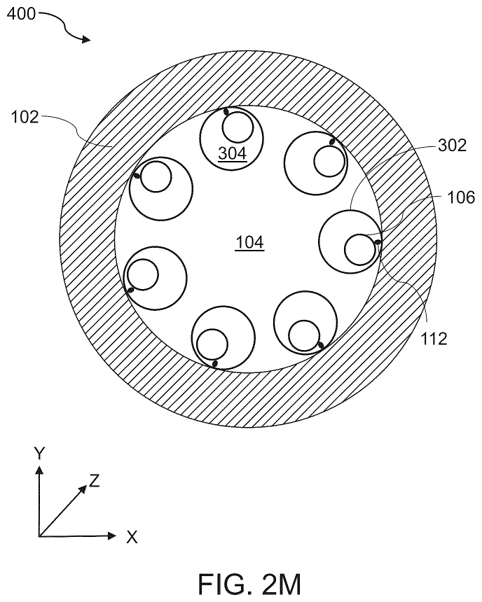

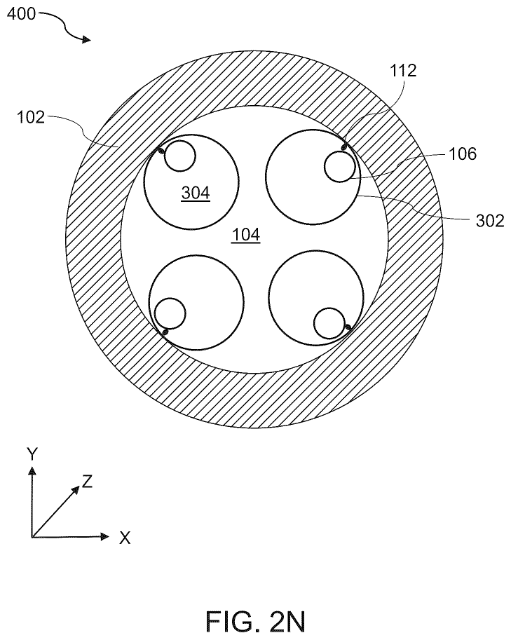

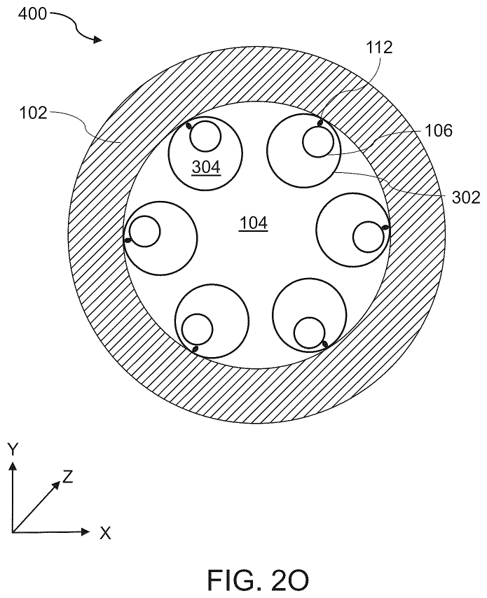

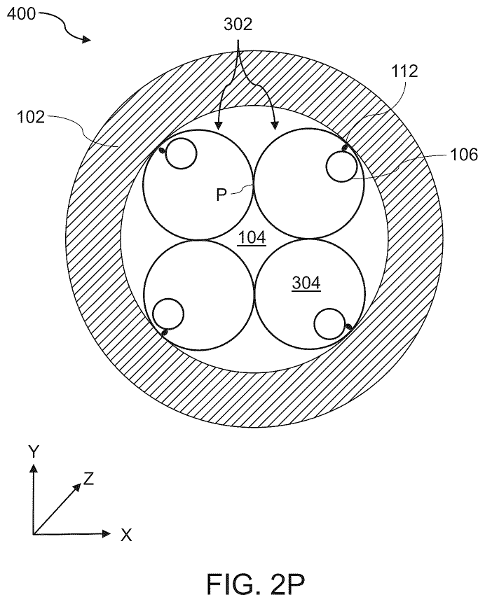

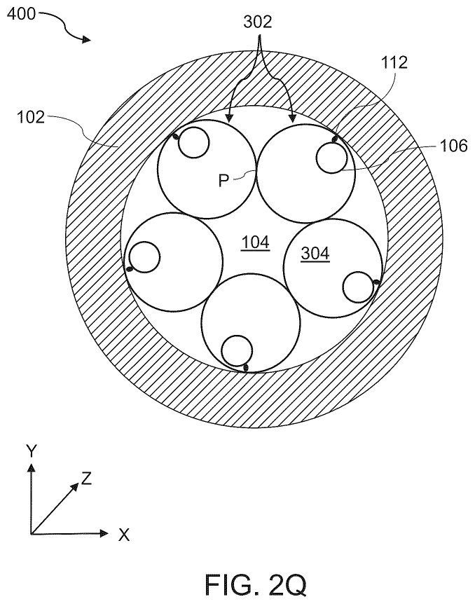

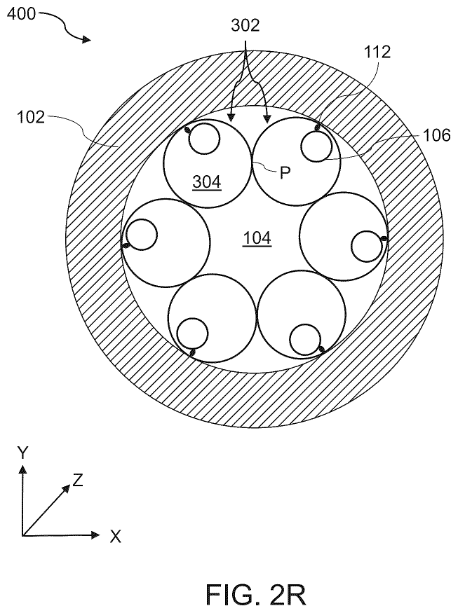

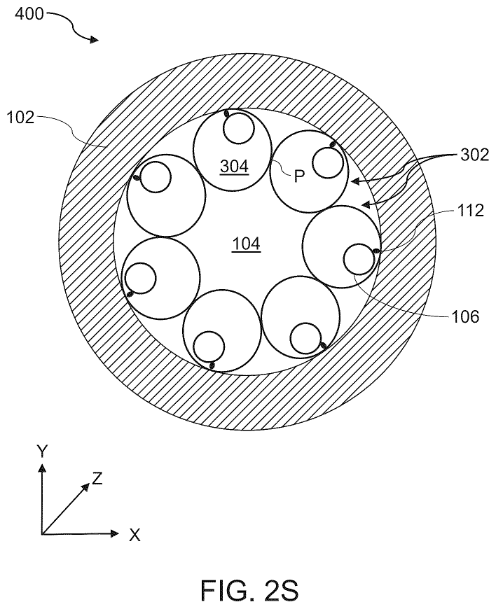

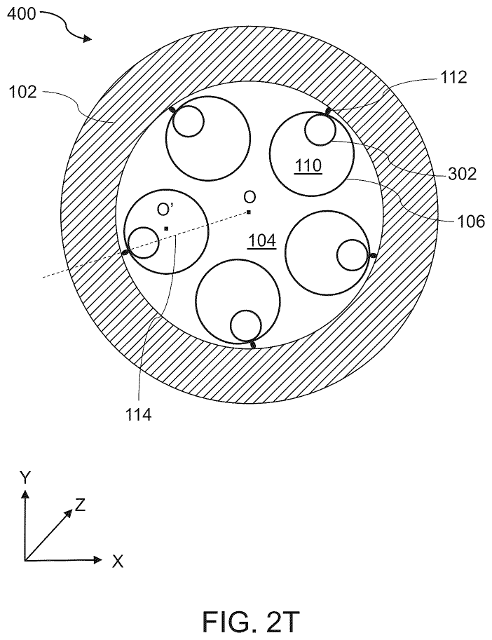

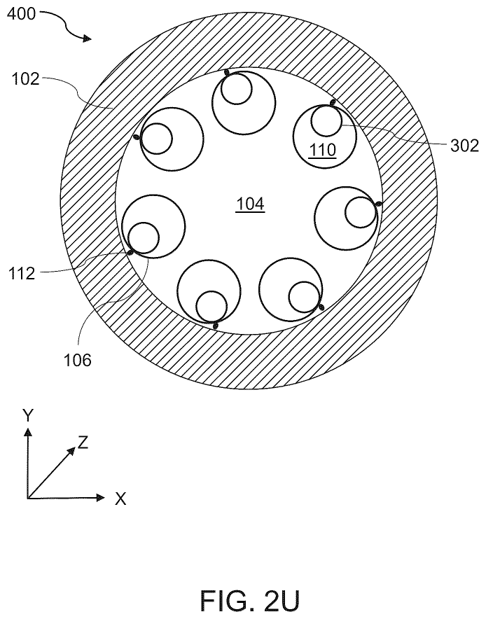

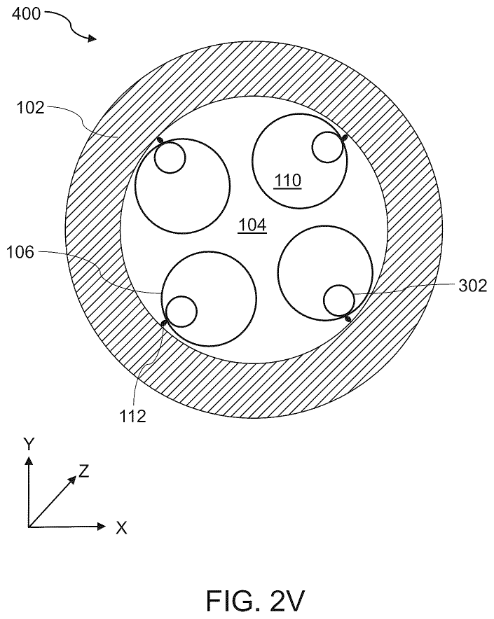

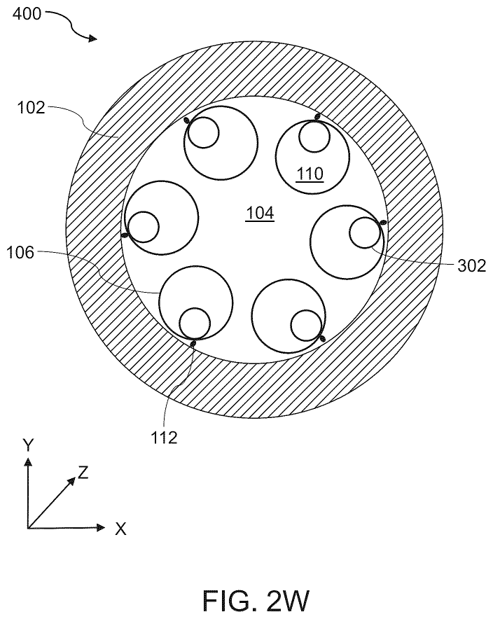

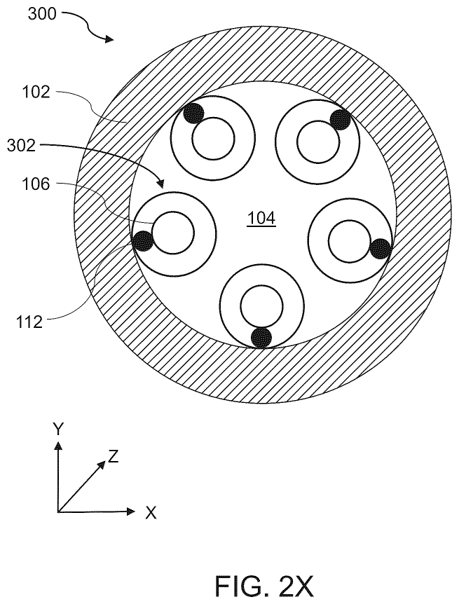

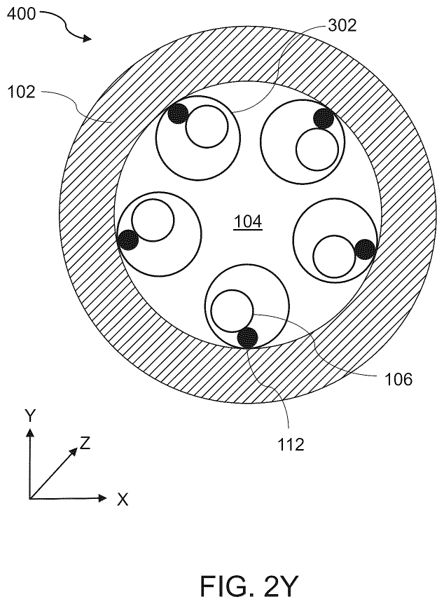

FIG. 2A depicts a cross-sectional view of an AR-HCF 300 with non-rotated AR elements 106. The AR-HCF 300 may be substantially similar to the AR-HCF 100 depicted in FIG. 1A, however, the AR-HCF 300 may further include one or more additional AR elements 302 (or “second AR elements”) that may “nest” the AR elements 106. Stated another way, in the AR-HCF 300, the AR elements 106 may be “nested” or disposed within the AR elements 302. Specifically, each AR element 106 may be located within an interior region 304 of the AR element 302 bounded by walls 306 of the AR element 302.

In some embodiments, the AR elements 302 may be made of similar material as the AR elements 106. In other embodiments, one or more AR elements 302 may be made of a material that may be different from the material of the AR elements 106. Further, the AR elements 302 may have the same cross-sectional shape as the AR elements 106, or may have different shapes. In the exemplary embodiment depicted in FIG. 2A, each AR element 302 is circular in cross-sectional shape (similar to the cross-sectional shape of the AR elements 106), with a diameter (or width) of each AR element 302 substantially greater than the diameter (or width) of the AR elements 106.

Furthermore, each AR element 302 may have the same or different refractive index as the AR elements 106, and may be under vacuum or filled with any gas (e.g., ambient air, nitrogen, argon, or any selected composition). In addition, the walls 306 of each AR element 302 may have the same or different thickness than the walls 108 of the AR elements 106. Further, in certain embodiments, each AR element 302 may have the same dimensions (e.g., width or diameter) as the other AR elements 302. In other embodiments, one or more AR elements 302 may have different dimensions than the other AR elements 302.

The exemplary embodiment of FIG. 2A shows the AR-HCF 300 as having five AR elements 302, where one AR element 106 is located in the interior region 304 of each AR element 302. Such depiction should not be construed as limiting, and the AR-HCF 300 may have more than one AR element 106 located in each AR element 302, or one or more AR elements 302 may not have any AR element 106.

In the AR-HCF 300 depicted in FIG. 2A, each AR element 302 is positioned on the interior surface of the cladding structure 102 such that a portion of the walls 306 of the AR element 302 contacts the interior surface of the cladding structure 102. In some aspects, the portion of the walls 306 that contacts the interior surface of the cladding structure 102 positions the AR element 302 on the cladding structure 102. Further, in the AR-HCF 300, the support structure 112 is positioned on the portion of the walls 306 that contacts the interior surface of the cladding structure 102, thereby facilitating in disposing the AR element 106 on the cladding structure 102 (via the support structure 112 and the walls 306). Stated another way, in the AR-HCF 300, the AR element 106 is positioned on the walls 306 (that position the AR element 302 on the cladding structure 102) via the support structure 112.

In the AR-HCF 300, the support structure 112, the center point “O′” of the AR element 106 and the center point “O” of the hollow interior region 104 are all aligned on the imaginary center line 114. As described above, while such an arrangement does frustrate the higher order modes to some extent, rotating the AR elements 106 within the interior region 304 of the AR element 302 about the support structure 112 considerably enhances the frustration of the higher order modes.

FIG. 2B depicts an AR-HCF 400 that may be substantially similar to the AR-HCF 300 described above, however, in the AR-HCF 400, the AR element 106 may be rotated in the interior region 304 about the support structure 112 relative to the imaginary center line 114, such that the imaginary center line 116 connecting the support structure 112 and the center point “O′” of the AR element 106 is offset by a non-zero angle “β” relative to the imaginary center line 114 connecting the support structure 112 and the center point “O” of the hollow interior region 104 (or relative to the imaginary center line connecting the AR element 302 and the center point “O” of the hollow interior region 104). The angle “β” may be equivalent to or different from the angle “α” described above. Although FIG. 2B shows an exemplary embodiment where the AR elements 106 are rotated in a clockwise direction, the present disclosure is not limited to such an embodiment. In alternative embodiments, the AR elements 106 may be rotated in a counterclockwise direction or rotated randomly (e.g., some AR elements 106 may be rotated in a clockwise direction and the remaining AR elements 106 may be rotated in a counterclockwise direction).

The AR-HCF 400 causes greater frustration of the higher order modes than the AR-HCF 300. Further, the losses in the fundamental mode experienced in the AR-HCF 400 are substantially equivalent to the losses experienced in AR-HCF 300. Experimental results of the losses in the fundamental mode and the higher order modes for AR-HCFs 300, 400 at different wavelengths are depicted in FIGS. 2C and 2D. The experimental results depicted in FIGS. 2C and 2D are for an AR-HCF that has a thickness of the wall 306 as 1.11 μm and a thickness of the wall 108 as 1.19 μm.

FIG. 2C depicts an exemplary first graph 402 between wavelengths of propagating light and signal losses in the fundamental mode for the AR-HCFs 300, 400, in accordance with one or more embodiments of the present disclosure. Specifically, in the graph 402, X-axis is the wavelength (nm) of light propagating through the AR-HCFs 300, 400, and Y-axis is the losses experienced in the fundamental mode. Further, a solid line 404 depicts the curve (losses vs wavelength) associated with the AR-HCF 300, and a dotted line 406 depicts the curve (losses vs wavelength) associated with the AR-HCF 400.

As can be appreciated from the graph 402, for most of the wavelength range (e.g., from 1300-1550 nm), the losses in the fundamental mode in the AR-HCFs 300 and 400 are substantially equivalent to each other. Therefore, rotating the AR elements 106 about the support structure 112 does not cause significant impact on the losses in the fundamental mode.

FIG. 2D depicts an exemplary second graph 408 between wavelengths of propagating light and signal losses in the higher order modes for the AR-HCFs 300, 400, in accordance with one or more embodiments of the present disclosure. Specifically, in the graph 408, X-axis is the wavelength (nm) of light propagating through the AR-HCFs 300, 400, and Y-axis is the losses experienced in the higher order modes. Further, a solid line 410 depicts the curve (losses vs wavelength) associated with the AR-HCF 300, and a dotted line 412 depicts the curve (losses vs wavelength) associated with the AR-HCF 400.

As can be appreciated from the graph 408, for most of the wavelength range (e.g., from 1350-1800 nm), the losses in the higher order mode for the AR-HCF 400 are substantially greater than the losses experienced in the AR-HCF 300. Therefore, it is apparent from the graph 408 that by rotating the AR elements 106 about the support structure 112, the AR-HCF 400 experiences substantially greater losses in the higher order modes (e.g., by causing them to radiate out into the cladding structure 102), thereby attenuating the higher order modes and significantly enhancing the beam quality and signal stability.

FIG. 2E depicts an exemplary third graph 414 between wavelengths of propagating light and signal losses in the fundamental mode for the AR-HCFs 300, 400, in accordance with one or more embodiments of the present disclosure. The graph 414 depicts experimental results for the AR-HCFs 300, 400 when the wall 306 has a thickness of 1.17 μm and the wall 108 has a thickness of 1.19 μm.

In the graph 414, X-axis is the wavelength (nm) of light propagating through the AR-HCFs 300, 400, and Y-axis is the losses experienced in the fundamental mode. Further, a solid line 416 depicts the curve (losses vs wavelength) associated with the AR-HCF 300, and a dotted line 418 depicts the curve (losses vs wavelength) associated with the AR-HCF 400.

As can be appreciated from the graph 414, for most of the wavelength range (e.g., from 1300-1750 nm), the losses in the fundamental mode in the AR-HCFs 300 and 400 are substantially equivalent to each other. Therefore, rotating the AR elements 106 about the support structure 112 does not cause significant impact on the losses in the fundamental mode.

FIG. 2F depicts an exemplary fourth graph 420 between wavelengths of propagating light and signal losses in the higher order modes for the AR-HCFs 300, 400, in accordance with one or more embodiments of the present disclosure. The graph 420 depicts experimental results for the AR-HCFs 300, 400 when the wall 306 has a thickness of 1.17 μm and the wall 108 has a thickness of 1.19 μm.

In the graph 420, X-axis is the wavelength (nm) of light propagating through the AR-HCFs 300, 400, and Y-axis is the losses experienced in the higher order modes. Further, a solid line 422 depicts the curve (losses vs wavelength) associated with the AR-HCF 300, and a dotted line 424 depicts the curve (losses vs wavelength) associated with the AR-HCF 400.

As can be appreciated from the graph 420, for most of the wavelength range (e.g., from 1200-1800 nm), the losses in the higher order mode for the AR-HCF 400 are substantially greater than the losses experienced in the AR-HCF 300. Therefore, it is apparent from the graph 420 that by rotating the AR elements 106 about the support structure 112, the AR-HCF 400 experiences substantially greater losses in the higher order modes (e.g., by causing them to radiate out into the cladding structure 102), thereby attenuating the higher order modes and significantly enhancing the beam quality and signal stability.

FIG. 2G depicts an exemplary fifth graph 426 between wavelengths of propagating light and signal losses in the fundamental mode for the AR-HCFs 300, 400, in accordance with one or more embodiments of the present disclosure. The graph 426 depicts experimental results for the AR-HCFs 300, 400 when the wall 306 has a thickness of 1.17 μm and the wall 108 has a thickness of 1.25 μm.

In the graph 426, X-axis is the wavelength (nm) of light propagating through the AR-HCFs 300, 400, and Y-axis is the losses experienced in the fundamental mode. Further, a solid line 428 depicts the curve (losses vs wavelength) associated with the AR-HCF 300, and a dotted line 430 depicts the curve (losses vs wavelength) associated with the AR-HCF 400.

As can be appreciated from the graph 426, for most of the wavelength range (e.g., from 1450-1750 nm), the losses in the fundamental mode in the AR-HCFs 300 and 400 are substantially equivalent to each other. Therefore, rotating the AR elements 106 about the support structure 112 does not cause significant impact on the losses in the fundamental mode.

FIG. 2H depicts an exemplary sixth graph 432 between wavelengths of propagating light and signal losses in the higher order modes for the AR-HCFs 300, 400, in accordance with one or more embodiments of the present disclosure. The graph 432 depicts experimental results for the AR-HCFs 300, 400 when the wall 306 has a thickness of 1.17 μm and the wall 108 has a thickness of 1.25 μm.

In the graph 432, X-axis is the wavelength (nm) of light propagating through the AR-HCFs 300, 400, and Y-axis is the losses experienced in the higher order modes. Further, a solid line 434 depicts the curve (losses vs wavelength) associated with the AR-HCF 300, and a dotted line 436 depicts the curve (losses vs wavelength) associated with the AR-HCF 400.

As can be appreciated from the graph 432, for most of the wavelength range (e.g., from 1300-1800 nm), the losses in the higher order mode for the AR-HCF 400 are substantially greater than the losses experienced in the AR-HCF 300. Therefore, it is apparent from the graph 432 that by rotating the AR elements 106 about the support structure 112, the AR-HCF 400 experiences substantially greater losses in the higher order modes (e.g., by causing them to radiate out into the cladding structure 102), thereby attenuating the higher order modes and significantly enhancing the beam quality and signal stability.

FIG. 2I depicts an exemplary seventh graph 438 that may be same as the first graph 402 described above. Stated another way, the graph 438 (with solid and dotted lines 440 and 442, which may be same as the solid and dotted lines 404, 406) may be associated with the AR-HCFs 300, 400 when the wall 306 has a thickness of 1.11 μm and the wall 108 has a thickness of 1.19 μm. FIG. 2J depicts an exemplary eighth graph 444 that may be associated with AR-HCFs 300, 400 where the thicknesses of the walls 108, 306 may be reversed. Stated another way, the graph 444 depicts experimental results for losses in the fundamental mode for the AR-HCFs 300, 400 when the wall 306 has a thickness of 1.19 μm and the wall 108 has a thickness of 1.11 μm.

In the graph 444, X-axis is the wavelength (nm) of light propagating through the AR-HCFs 300, 400, and Y-axis is the losses experienced in the fundamental mode. Further, a solid line 446 depicts the curve (losses vs wavelength) associated with the AR-HCF 300, and a dotted line 448 depicts the curve (losses vs wavelength) associated with the AR-HCF 400.

As can be appreciated from the graph 444, for most of the wavelength range (e.g., from 1300-1750 nm), the losses in the fundamental mode in the AR-HCFs 300 and 400 are substantially equivalent to each other. Therefore, rotating the AR elements 106 about the support structure 112 does not cause significant impact on the losses in the fundamental mode.

FIG. 2K depicts an exemplary ninth graph 450 between wavelengths of propagating light and signal losses in the fundamental mode for the AR-HCFs 300, 400, in accordance with one or more embodiments of the present disclosure. The graph 450 depicts experimental results for the AR-HCFs 300, 400 when the wall 306 has a thickness of 0.35 μm and the wall 108 has a thickness of 0.43 μm.

In the graph 450, X-axis is the wavelength (nm) of light propagating through the AR-HCFs 300, 400, and Y-axis is the losses experienced in the fundamental mode. Further, a solid line 452 depicts the curve (losses vs wavelength) associated with the AR-HCF 300, and a dotted line 454 depicts the curve (losses vs wavelength) associated with the AR-HCF 400.

As can be appreciated from the graph 450, for most of the wavelength range (e.g., from 1200-1800 nm), the losses in the fundamental mode in the AR-HCFs 300 and 400 are substantially equivalent to each other. Therefore, rotating the AR elements 106 about the support structure 112 does not cause significant impact on the losses in the fundamental mode.

FIG. 2L depicts an exemplary tenth graph 456 between wavelengths of propagating light and signal losses in the fundamental mode for the AR-HCFs 300, 400, in accordance with one or more embodiments of the present disclosure. The graph 456 depicts experimental results for the AR-HCFs 300, 400 when the wall 306 has a thickness of 0.43 μm and the wall 108 has a thickness of 0.35 μm.

In the graph 456, X-axis is the wavelength (nm) of light propagating through the AR-HCFs 300, 400, and Y-axis is the losses experienced in the fundamental mode. Further, a solid line 458 depicts the curve (losses vs wavelength) associated with the AR-HCF 300, and a dotted line 460 depicts the curve (losses vs wavelength) associated with the AR-HCF 400.

As can be appreciated from the graph 456, for most of the wavelength range (e.g., from 1200-1800 nm), the losses in the fundamental mode in the AR-HCFs 300 and 400 are substantially equivalent to each other. Therefore, rotating the AR elements 106 about the support structure 112 does not cause significant impact on the losses in the fundamental mode.

FIG. 2M depicts an embodiment of the AR-HCF 400 that has seven AR elements 302 distributed within the hollow interior region 104, and each AR element 302 has an AR element 106 located within the interior region 304 of the AR element 302. In the embodiment of FIG. 2M, the arrangement of the AR element 106 within the interior region 304 of the AR element 302 may be the same as the arrangement described above in conjunction with FIG. 2B. In this embodiment also, the AR elements 106 may be rotated (in the clockwise or counterclockwise direction) about the support structure 112 relative to the imaginary center line 114 in the similar manner as described above, to significantly frustrate the higher order modes.

FIG. 2N depicts an embodiment of the AR-HCF 400 that has four AR elements 302 distributed within the hollow interior region 104, and each AR element 302 has an AR element 106 located within the interior region 304 of the AR element 302. In the embodiment of FIG. 2N, the arrangement of the AR element 106 within the interior region 304 of the AR element 302 may be the same as the arrangement described above in conjunction with FIG. 2B. In this embodiment also, the AR elements 106 may be rotated (in the clockwise or counterclockwise direction) about the support structure 112 relative to the imaginary center line 114 in the similar manner as described above, to significantly frustrate the higher order modes.

FIG. 2O depicts an embodiment of the AR-HCF 400 that has six AR elements 302 distributed within the hollow interior region 104, and each AR element 302 has an AR element 106 located within the interior region 304 of the AR element 302. In the embodiment of FIG. 2O, the arrangement of the AR element 106 within the interior region 304 of the AR element 302 may be the same as the arrangement described above in conjunction with FIG. 2B. In this embodiment also, the AR elements 106 may be rotated (in the clockwise or counterclockwise direction) about the support structure 112 relative to the imaginary center line 114 in the similar manner as described above, to significantly frustrate the higher order modes.

FIG. 2P depicts an embodiment of the AR-HCF 400 that has four AR elements 302 distributed within the hollow interior region 104, and each AR element 302 may touch adjacent AR elements 302, e.g., at an intersection point “P”. Similar to the embodiments described above, in the embodiment of FIG. 2P as well, each AR element 302 has an AR element 106 located within the interior region 304 of the AR element 302. In this embodiment also, the AR elements 106 may be rotated (in the clockwise or counterclockwise direction) about the support structure 112 relative to the imaginary center line 114 in the similar manner as described above, to significantly frustrate the higher order modes.

FIG. 2Q depicts an embodiment of the AR-HCF 400 that has five AR elements 302 distributed within the hollow interior region 104, and each AR element 302 may touch adjacent AR elements 302, e.g., at the intersection point “P”. Similar to the embodiments described above, in the embodiment of FIG. 2Q as well, each AR element 302 has an AR element 106 located within the interior region 304 of the AR element 302. In this embodiment also, the AR elements 106 may be rotated (in the clockwise or counterclockwise direction) about the support structure 112 relative to the imaginary center line 114 in the similar manner as described above, to significantly frustrate the higher order modes.

FIG. 2R depicts an embodiment of the AR-HCF 400 that has six AR elements 302 distributed within the hollow interior region 104, and each AR element 302 may touch adjacent AR elements 302, e.g., at the intersection point “P”. Similar to the embodiments described above, in the embodiment of FIG. 2R as well, each AR element 302 has an AR element 106 located within the interior region 304 of the AR element 302. In this embodiment also, the AR elements 106 may be rotated (in the clockwise or counterclockwise direction) about the support structure 112 relative to the imaginary center line 114 in the similar manner as described above, to significantly frustrate the higher order modes.

FIG. 2S depicts an embodiment of the AR-HCF 400 that has seven AR elements 302 distributed within the hollow interior region 104, and each AR element 302 may touch adjacent AR elements 302, e.g., at the intersection point “P”. Similar to the embodiments described above, in the embodiment of FIG. 2S as well, each AR element 302 has an AR element 106 located within the interior region 304 of the AR element 302. In this embodiment also, the AR elements 106 may be rotated (in the clockwise or counterclockwise directions) about the support structure 112 relative to the imaginary center line 114 in the similar manner as described above, to significantly frustrate the higher order modes.

FIG. 2T depicts an embodiment of the AR-HCF 400 in which the AR element 302 is located within the interior region 110 of the AR element 106 bounded by the walls 108 of the AR element 106. In this specific embodiment, the width or diameter of the AR element 302 may be less than the width or diameter of the AR element 106.

In the embodiment depicted in FIG. 2T, the support structure 112 may directly position the AR element 106 on the interior surface of the cladding structure 102. Specifically, in this embodiment, the support structure 112 may be outside the AR elements 106 and 302, but inside the cladding structure 102. Further, in this case, a portion of the walls 306 of the AR element 302 may be disposed on the interior surface of the walls 108 of the AR element 106, to position the AR element 302 within the interior region 110 of the AR element 106.

In this embodiment as well, the AR elements 106 may be rotated (in the clockwise or counterclockwise direction) about the support structure 112 relative to the imaginary center line 114 in the similar manner as described above, to significantly frustrate the higher order modes. In embodiments described herein, additional AR elements may be located within the outermost AR element. For example, a second AR element may be positioned within the first AR element and a third AR element may be positioned within the second AR element.

AR-HCF structures similar to the one shown in FIG. 2T are possible, in which the AR-HCF may include less or more than five AR elements 106 and/or where one or more AR elements 106 may touch adjacent AR elements 106. Examples of some of the AR-HCF structures similar to the one shown in FIG. 2T are depicted in FIGS. 2U, 2V and 2W, and described below.

FIG. 2U depicts an embodiment of the AR-HCF 400 that is substantially similar to the embodiment depicted in FIG. 2T; however, in the embodiment of the AR-HCF 400 depicted in FIG. 2U, the AR-HCF 400 includes seven AR elements 106, and each AR element 106 has a nested AR element 302 disposed within the interior region 110 of the AR element 106. The nested AR elements 106, 302 are connected to the cladding structure 102 via the support structure 112, which rests on the interior surface of the cladding structure 102 and is disposed outside the AR elements 106, 302.

In this embodiment as well, the AR elements 106 may be rotated (in the clockwise or counterclockwise direction) about the support structure 112 relative to the imaginary center line 114 in the similar manner as described above, to significantly frustrate the higher order modes. In embodiments described herein, additional AR elements may be located within the outermost AR element. For example, a second AR element may be positioned within the first AR element and a third AR element may be positioned within the second AR element.

FIG. 2V depicts an embodiment of the AR-HCF 400 that is substantially similar to the embodiment depicted in FIG. 2T; however, in the embodiment of the AR-HCF 400 depicted in FIG. 2V, the AR-HCF 400 includes four AR elements 106, and each AR element 106 has a nested AR element 302 disposed within the interior region 110 of the AR element 106. The nested AR elements 106, 302 are connected to the cladding structure 102 via the support structure 112, which rests on the interior surface of the cladding structure 102 and is disposed outside the AR elements 106, 302.

In this embodiment as well, the AR elements 106 may be rotated (in the clockwise or counterclockwise direction) about the support structure 112 relative to the imaginary center line 114 in the similar manner as described above, to significantly frustrate the higher order modes.

FIG. 2W depicts an embodiment of the AR-HCF 400 that is substantially similar to the embodiment depicted in FIG. 2T; however, in the embodiment of the AR-HCF 400 depicted in FIG. 2W, the AR-HCF 400 includes six AR elements 106, and each AR element 106 has a nested AR element 302 disposed within the interior region 110 of the AR element 106. The nested AR elements 106, 302 are connected to the cladding structure 102 via the support structure 112, which rests on the interior surface of the cladding structure 102 and is disposed outside the AR elements 106, 302.

In this embodiment as well, the AR elements 106 may be rotated (in the clockwise or counterclockwise direction) about the support structure 112 relative to the imaginary center line 114 in the similar manner as described above, to significantly frustrate the higher order modes.

FIG. 2X depicts an embodiment of AR-HCF 300 with non-rotated AR elements 106, which may be substantially similar to the embodiment of the AR-HCF 300 depicted in FIG. 2A and described above. However, in the AR-HCF 300 of FIG. 2X, the support structure 112 may be substantially thicker, so that the AR elements 106 and 302 may be concentric. Stated another way, in the AR-HCF 300 of FIG. 2X, the centers of the AR elements 106 and 302 may be aligned or overlap with each other (or the AR elements 106 may be positioned at the centers of the AR elements 302). In this case, the thickness of the support structure 112 may depend on the diameter of the nested AR elements 106, such that the AR elements 106 and 302 may be concentric.

FIG. 2Y depicts an embodiment of the AR-HCF 400 that may be substantially similar to the AR-HCF 300 of FIG. 2X described above, however, in the AR-HCF 400 of FIG. 2Y, the AR element 106 may be rotated (in the clockwise or counterclockwise direction or in a random manner) about the support structure 112 relative to the imaginary center line 114 in the similar manner as described above, to significantly frustrate the higher order modes. In this case, when the AR elements 106 are rotated, the AR elements 106 and 302 may not remain concentric.

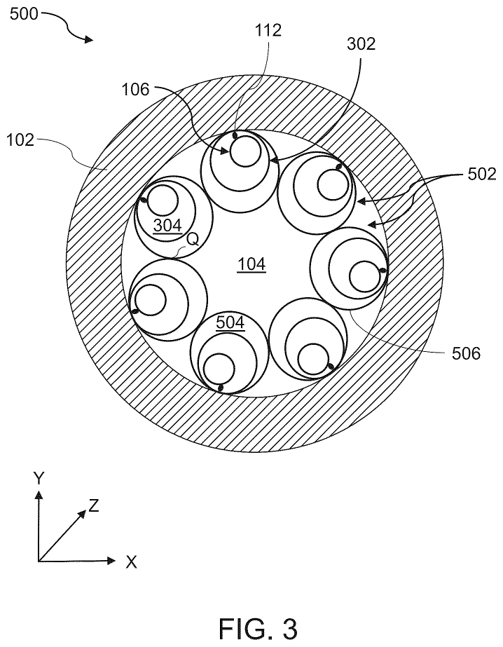

FIG. 3 depicts a cross-sectional view of an AR-HCF 500, which is similar to the AR-HCF 400 depicted in FIG. 2S and described above; however, the AR-HCF 500 may additionally include “larger” AR elements 502 that may enclose the smaller AR elements 302 (which may themselves enclose further smaller AR elements 106). Consequently, in the AR-HCF 500, each AR element 106 may be located within the interior region 304 of the AR element 302 bounded by the walls 306 of the AR element 302, and each AR element 302 may be located within an interior region 504 of the AR element 502 bounded by walls 506 of the AR element 502. Further, each AR element 502 may touch adjacent AR elements 502 at an intersection point “Q”.

Similar to the AR-HCFs described above, in the AR-HCF 500 as well, the AR elements 106 may be rotated (in the clockwise or counterclockwise direction) about the support structure 112 relative to the imaginary center line 114 in the similar manner as described above, to significantly frustrate the higher order modes.

In embodiments described herein, additional AR elements may be located within the outermost AR element. For example, a second AR element may be positioned within the first AR element and a third AR element may be positioned within the second AR element.

Although FIG. 3 depicts the AR-HCF 500 as having seven AR elements 106, 302, 502, the present disclosure is not limited to such an embodiment. In alternative embodiments, the AR-HCF 500 may include more or less than seven AR elements 106, 302, 502. Further, in certain embodiments, one or more AR elements 502 may not include the AR elements 106 and/or 302. Furthermore, in certain embodiments, one or more AR elements 502 may not touch adjacent AR elements 502.

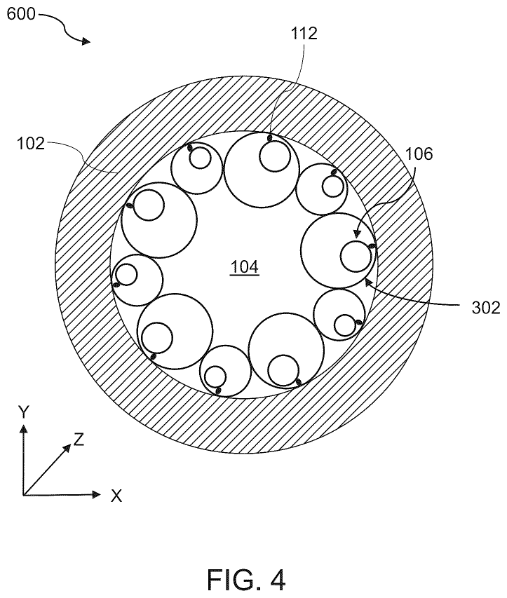

FIG. 4 depicts a cross-sectional view of an AR-HCF 600, which is similar to the AR-HCF 400 depicted in FIGS. 2P-2S and described above; however, in the AR-HCF 600, two “smaller” AR elements 302 may touch one “larger” AR element 302 on opposite sides. Further, in the AR-HCF 600, two “larger” AR elements 302 may touch one “smaller” AR element 302 on opposite sides. Furthermore, in the AR-HCF 600, the larger AR element 302 may enclose a relatively larger AR element 106, and the smaller AR element 302 may enclose a smaller AR element 106. Stated another way, in the AR-HCF 600, the diameter/width of adjacent AR elements 302, 106 may alternate between large and small.

Similar to the AR-HCFs described above, in the AR-HCF 600 as well, the AR elements 106 may be rotated (in the clockwise or counterclockwise direction) about the support structure 112 relative to the imaginary center line 114 in the similar manner as described above, to significantly frustrate the higher order modes.

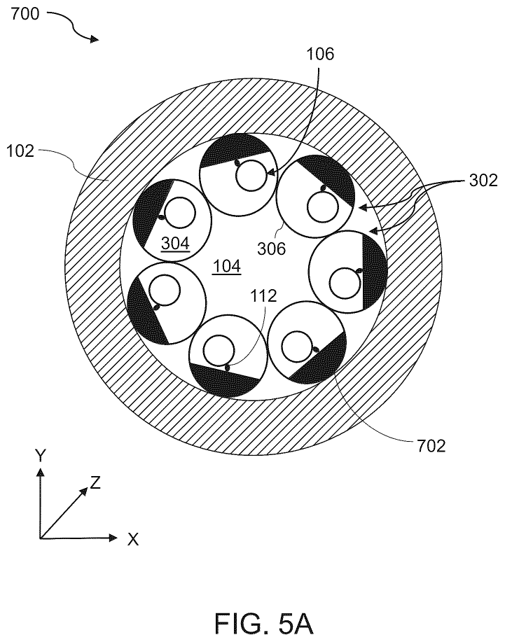

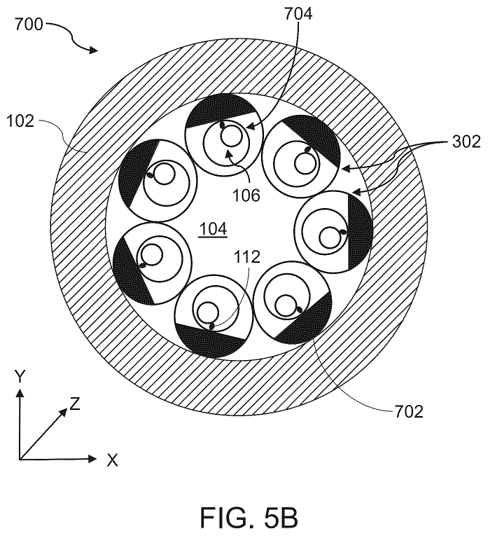

FIG. 5A depicts a cross-sectional view of an AR-HCF 700, which may include one or more AR elements 302 (e.g., seven AR element 302 as shown in FIG. 5A) that may be positioned on the interior surface of the cladding structure 102. The AR-HCF 700 may further include one or more support slabs 702, which may position at least one AR element 302 within the AR-HCF 700. For example, at least one AR element 302 may be connected to at least one support slab 702. The support slabs 702 may generally be formed as or be in contact with (or positioned on) the interior surface of the cladding structures 102 and/or any of the AR elements 302.

The support slabs 702 may extend along the fiber length and may generally have any shape suitable for positioning one or more connected AR elements 302 within the hollow interior region 104 of the AR-HCF 700 such as, but not limited to, a circle, an ellipse, a truncated circle, a truncated ellipse, or any multi-faced shape. Further, a support slab 702 may be attached to or incorporated as part of an AR element 302 or the cladding structure 102. In some embodiments, a support slab 702 is formed as a portion of the wall 306 of an AR element 302. Put another way, in this case, the AR element 302 may have the wall 306 with a non-uniform thickness profile, where a portion of the wall 306 (e.g., a relatively thick portion) may form a support slab 702. In this manner, the support slab 702 may have a non-uniform thickness profile. In this configuration, the non-uniform thickness profile of the wall 306 may define a shape of the support slab 702. It is thus noted that while various figures throughout the present disclosure may depict the support slab 702 and the walls 306 as separate elements, this is merely illustrative of some embodiments and not limiting. Rather, any of the support slabs 702 may be formed directly as part of the wall 306.

Different support slabs 702 may be formed from a different material than other support slabs 702. Further, the support slabs 702 may be formed of the same material as the AR elements 302, or may be formed of a different material. For example, a support slab 702 may be formed from a different material than a connected AR element 302. Furthermore, in certain embodiments, the index of refraction of the AR elements 302 is different from the index of refraction of the support slabs 702. In addition, one of more support slabs 702 may have a different index of refraction from other support slabs 702.

In the AR-HCF 700 of FIG. 5A, the support slab 702 is connected to the interior surface of the cladding structure 102 and is located in the interior region 304. Further, the nested AR elements 106 may be positioned on the support slab 702. Specifically, in the AR-HCF 700, the support structure 112 is positioned on the support slab 702, which enables the AR element 106 to be positioned on the support slab 702. Further, the AR element 302 may be positioned on the interior surface of the cladding structure 102 such that a portion of the support slab 702 contacts the interior surface of the cladding structure 102, as shown in FIG. 5A.

In some aspects, the shape of the support slab 702 may be tailored based on fiber-draw parameters, such as draw speed, draw tension, surface tension, draw ratio, temperature, AR-element material, and differential pressures. The support slab 702 may be chosen to produce a specific, optimized geometry in the final hollow-core fiber. These improvements can aid manufacturing tolerance and stability throughout the fiber-fabrication process.

Similar to the AR-HCFs described above, in the AR-HCF 700 as well, the AR elements 106 may be rotated (in the clockwise or counterclockwise direction) about the support structure 112 relative to the imaginary center line 114 in the similar manner as described above, to significantly frustrate the higher order modes.

FIG. 5B depicts an embodiment of the AR-HCF 700, which may be substantially similar to the embodiment of the AR-HCF 700 depicted in FIG. 5A and described above; however, in the AR-HCF 700 of FIG. 5B, a “large” AR element 704 may enclose the “smaller” AR element 106, and the AR element 704 may be positioned on the support slab 702. Specifically, in this case, a portion of walls of the AR element 704 may contact the interior surface of the support slab 702, thereby positioning the AR element 704 on the support slab 702. Further, the support structure 112 may be positioned on the portion of the walls of the AR element 704 that contacts the interior surface of the support slab 702, thereby positioning the AR element 106 on the AR element 704. Further, in this case, the width/diameter of the AR element 302 may be greater than the width/diameter of the AR element 704, which in turn may be greater than the width/diameter of the AR element 106.

Similar to the AR-HCFs described above, in the AR-HCF 700 of FIG. 5B as well, the AR elements 106 may be rotated (in the clockwise or counterclockwise direction) about the support structure 112 relative to the imaginary center line 114 in the similar manner as described above, to significantly frustrate the higher order modes.

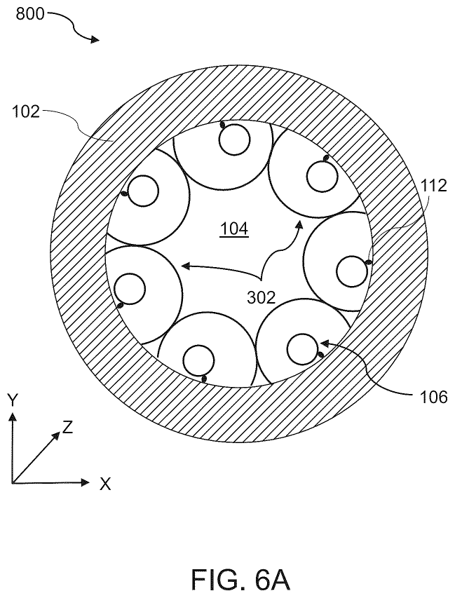

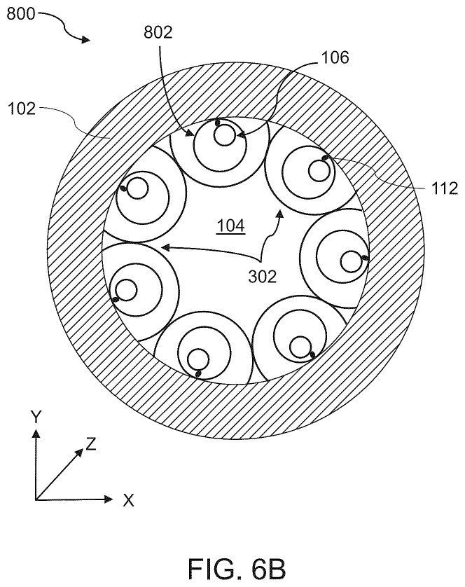

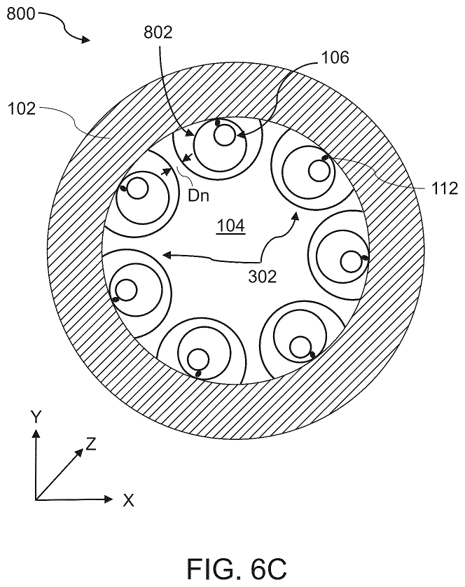

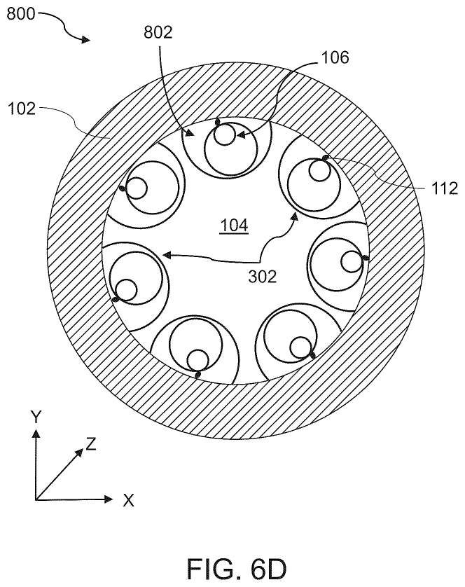

FIG. 6A depicts a cross-sectional view of an AR-HCF 800, which may be similar to the AR-HCF 400 depicted in FIG. 2S, however in the AR-HCF 800, each AR element 302 may not have a cross-sectional shape of a full circle, but may instead have a cross-sectional shape of a truncated circle or a semi-circle. Further, in the AR-HCF 800, the support structure 112 may be directly connected to the interior surface of the cladding structure 102, which may position or dispose the AR element 106 on the cladding structure 102. Similar to the AR-HCFs described above, in the AR-HCF 800 as well, the AR elements 106 may be rotated (in the clockwise or counterclockwise direction) about the support structure 112 relative to the imaginary center line 114 in the similar manner as described above, to significantly frustrate the higher order modes.

FIG. 6B depicts an embodiment of the AR-HCF 800, which may similar to the embodiment of the AR-HCF 800 depicted in FIG. 6A and described above, however, in the AR-HCF 800 of FIG. 6B, a “large” AR element 802 may enclose the “smaller” AR element 106, and the AR element 802 may be positioned on the interior surface of the cladding structure 102. Specifically, in this case, a portion of walls of the AR element 802 may contact the interior surface of the cladding structure 102, thereby positioning the AR element 802 on the cladding structure 102. Further, the support structure 112 may be positioned on the portion of the walls of the AR element 802 that contacts the interior surface of the cladding structure 102, thereby positioning the AR element 106 on the AR element 802. Further, the AR element 302 may enclose the AR element 802. Similar to the embodiment described above, in this case as well, the AR element 302 may have a cross-sectional shape of a truncated circle or a semi-circle.

Similar to the AR-HCFs described above, in the AR-HCF 800 of FIG. 6B as well, the AR elements 106 may be rotated (in the clockwise or counterclockwise direction) about the support structure 112 relative to the imaginary center line 114 in the similar manner as described above, to significantly frustrate the higher order modes.

FIG. 6C depicts an embodiment of the AR-HCF 800 that may similar to the embodiment of the AR-HCF 800 depicted in FIG. 6B and described above, however, in the AR-HCF 800 of FIG. 6C, the AR element 302 may not touch each other. Specifically, in the AR-HCF 800 of FIG. 6C, adjacent AR elements 302 may be disposed a non-zero distance “Dn” away from each other. The remaining details of the AR-HCF 800 of FIG. 6C are the same as the details of the AR-HCF 800 of FIG. 6B.

FIG. 6D depicts an embodiment of the AR-HCF 800 that may be substantially similar to the embodiment of the AR-HCF 800 depicted in FIG. 6C and described above, however, in the AR-HCF 800 of FIG. 6D, the support structure 112 may be connected to the interior surface of the cladding structure 102. Further, the nested AR elements 106, 802 are connected to the cladding structure 102 via the support structure 112, which rests on the interior surface of the cladding structure 102 and is disposed outside the AR elements 106, 802. The remaining details of the AR-HCF 800 of FIG. 6D are the same as the details of the AR-HCF 800 of FIG. 6C.

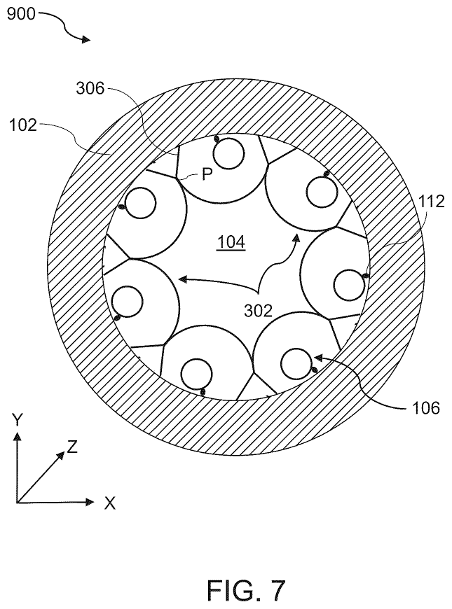

FIG. 7 depicts a cross-sectional view of an AR-HCF 900, which is similar to the AR-HCF 800 depicted in FIG. 6A and described above, however in the AR-HCF 900, the portion of the wall 306 of each AR element 302 that connects the intersection point “P” and the cladding structure 102 may be straight (as opposed to being curved).

Similar to the AR-HCFs described above, in the AR-HCF 900 as well, the AR elements 106 may be rotated (in the clockwise or counterclockwise direction) about the support structure 112 relative to the imaginary center line 114 in the similar manner as described above, to significantly frustrate the higher order modes.

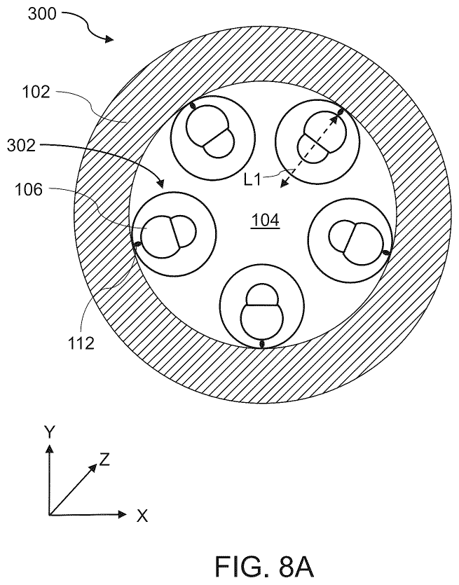

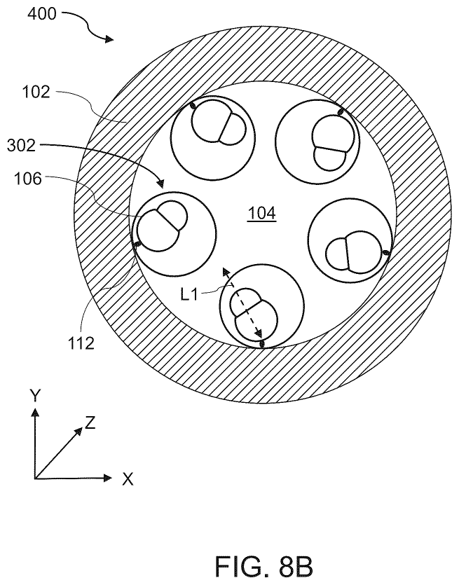

FIG. 8A depicts an embodiment of AR-HCF 300 with non-rotated AR elements 106, which may be substantially similar to the embodiment of the AR-HCF 300 depicted in FIG. 2A and described above. However, in the AR-HCF 300 of FIG. 8A, the AR elements 106 may not be circular, but may be shaped as figure “8” or like a snowman. In the embodiment of the AR-HCF 300 of FIG. 8A, a longitudinal axis “L1” of the snowman-shaped AR elements 106 may be aligned with the imaginary center line 114.

FIG. 8B depicts an embodiment of the AR-HCF 400 that may be substantially similar to the AR-HCF 300 of FIG. 8A described above, however, in the AR-HCF 400 of FIG. 8B, the snowman-shaped AR element 106 may be rotated (in the clockwise or counterclockwise direction or in a random manner) about the support structure 112 relative to the imaginary center line 114 in the similar manner as described above, to significantly frustrate the higher order modes. In this case, the longitudinal axis “L1” of the snowman-shaped AR elements 106 may not be aligned with the imaginary center line 114.

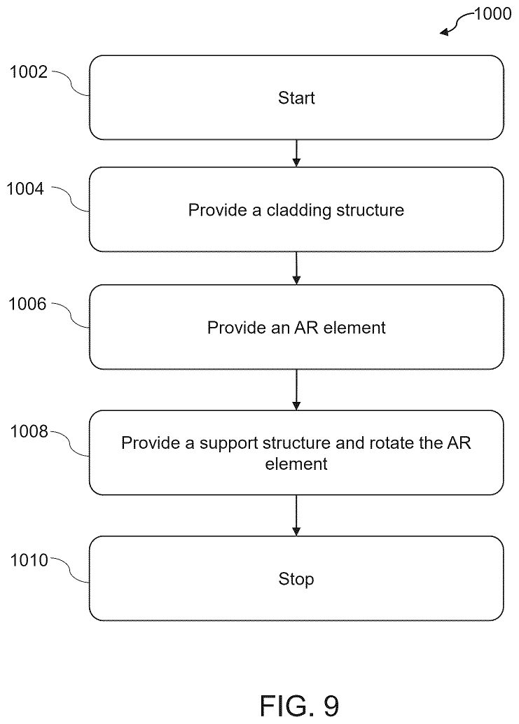

FIG. 9 is a flow diagram of a method 1000 to make the AR-HCF 200 in accordance with one or more embodiments of the present disclosure. Applicant notes that the embodiments and enabling technologies described previously herein in the context of the AR-HCF 200 should be interpreted to extend to the method 1000. It is further noted, however, that the method 1000 is not limited to the architecture/structure/operation of the AR-HCF 200 described above. The steps described in conjunction with the method 1000 may be performed by an operator or a controller/processor.

The method 1000 may start at step 1002. At step 1004, the method 1000 may include providing the cladding structure 102 that extends along the fiber length providing the hollow interior fiber region 104. At step 1006, the method 1000 may include providing the AR element 106 distributed within the hollow interior fiber region 104. At step 1008, the method 1000 may include providing the support structure 112 that positions the AR element 106 on the interior surface of the cladding structure 102, and rotating the AR element 106 in the hollow interior fiber region 104 such that the imaginary center line 116 connecting the support structure 112 and the center point “O′” of the AR element 106 is offset by the non-zero angle “α” relative to the imaginary center line 114 connecting the support structure 112 and the center point “O” of the hollow interior fiber region 104.

The method 1000 may end at step 1010.

In particular embodiments, certain features described herein in the context of separate implementations may also be combined and implemented in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variations of a sub-combination.

While operations may be depicted in the drawings as occurring in a particular order, this should not be understood as requiring that such operations be performed in the particular order shown or in sequential order, or that all operations be performed. Further, the drawings may schematically depict one more example processes or methods in the form of a flow diagram or a sequence diagram. However, other operations that are not depicted may be incorporated in the example processes or methods that are schematically illustrated. For example, one or more additional operations may be performed before, after, simultaneously with, or between any of the illustrated operations. Moreover, one or more operations depicted in a diagram may be repeated, where appropriate. Additionally, operations depicted in a diagram may be performed in any suitable order. Furthermore, although particular components, devices, or systems are described herein as carrying out particular operations, any suitable combination of any suitable components, devices, or systems may be used to carry out any suitable operation or combination of operations. In certain circumstances, multitasking or parallel processing operations may be performed. Moreover, the separation of various system components in the implementations described herein should not be understood as requiring such separation in all implementations, and it should be understood that the described program components and systems may be integrated together in a single software product or packaged into multiple software products.

Various embodiments have been described in connection with the accompanying drawings. However, it should be understood that the figures may not necessarily be drawn to scale. As an example, distances or angles depicted in the figures are illustrative and may not necessarily bear an exact relationship to actual dimensions or layouts of the devices illustrated.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes or illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend.

The term “or” as used herein is to be interpreted as an inclusive or meaning any one or any combination, unless expressly indicated otherwise or indicated otherwise by context. Therefore, herein, the expression “A or B” means “A, B, or both A and B.” As another example, herein, “A, B or C” means at least one of the following: A; B; C; A and B; A and C; B and C; A, B and C. An exception to this definition will occur if a combination of elements, devices, steps, or operations is in some way inherently mutually exclusive.

As used herein, words of approximation such as, without limitation, “approximately, “substantially,” or “about” refer to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as having the required characteristics or capabilities of the unmodified feature. In general, but subject to the preceding discussion, a numerical value herein that is modified by a word of approximation such as “approximately” may vary from the stated value by ±0.5%, ±1%, ±2%, ±3%, ±4%, ±5%, ±10%, ±12%, or ±15%. The term “substantially constant” refers to a value that varies by less than a particular amount over any suitable time interval. For example, a value that is substantially constant may vary by less than or equal to 20%, 10%, 1%, 0.5%, or 0.1% over a time interval of approximately 10⁴ s, 10³ s, 10² s, 10 s, 1 s, 100 ms, 10 ms, 1 ms, 100 μs, 10 μs, or 1 μs. The term “substantially constant” may be applied to any suitable value, such as for example, an optical power, a pulse repetition frequency, an electrical current, a wavelength, an optical or electrical frequency, or an optical or electrical phase.

As used herein, the terms “first,” “second,” “third,” etc. may be used as labels for nouns that they precede, and these terms may not necessarily imply a particular ordering (e.g., a particular spatial, temporal, or logical ordering). As an example, a system may be described as determining a “first result” and a “second result,” and the terms “first” and “second” may not necessarily imply that the first result is determined before the second result.

As used herein, the terms “based on” and “based at least in part on” may be used to describe or present one or more factors that affect a determination, and these terms may not exclude additional factors that may affect a determination. A determination may be based solely on those factors which are presented or may be based at least in part on those factors. The phrase “determine A based on B” indicates that B is a factor that affects the determination of A. In some instances, other factors may also contribute to the determination of A. In other instances, A may be determined based solely on B.

Although the foregoing embodiments in the present disclosure have been described in some detail for purposes of clarity of understanding, the invention is not limited to the details provided. There are many alternative ways of implementing the invention. The disclosed embodiments are illustrative and not restrictive.

What is claimed is:

1. An optical fiber comprising:
a cladding structure extending along a fiber length providing a hollow interior fiber region;
one or more sets of anti-resonant (AR) elements distributed within the hollow interior fiber region wherein the one or more sets of grouped AR elements is configured to guide light along the fiber length in a central portion of the hollow interior fiber region based on optical anti-resonance, the set of grouped AR elements comprising;
a first AR element disposed on the interior surface of the cladding structure;
a support structure disposed on an interior surface of the first AR element; and
a second AR element disposed on the support structure, wherein the second AR element is rotated such that a first center line connecting a center point of the second AR element and a center point of the support structure is offset by a non-zero angle relative to a second center line connecting a center of the first AR element and a center point of the hollow interior fiber region.

2. The optical fiber of claim 1, wherein each set of AR elements further comprises a third AR element, wherein the third AR element is located within an interior region of the second AR element bounded at least in part by walls of the second AR element.

3. The optical fiber of claim 2, wherein a width or diameter of the second AR element is greater than a width or diameter of the third AR element.

4. The optical fiber of claim 1, wherein the one or more sets of AR elements comprises three sets of AR elements.

5. The optical fiber of claim 1, wherein the one or more sets of AR elements comprises at least four sets of AR elements.

6. The optical fiber of claim 1, wherein a width or diameter of the first AR element is greater than a width or diameter of the second AR element.

7. The optical fiber of claim 1, wherein a thickness of the walls of the second AR element is different from a thickness of walls of the first AR element.

8. The optical fiber of claim 1, further comprising a fourth AR element.

9. The optical fiber of claim 1, wherein the support structure has a cross-sectional shape as one of: a circle, an ellipse, a square, or a rectangle.

10. The optical fiber of claim 1, wherein each non-zero angle is in a range of 1 to 15 degrees.

11. An optical fiber comprising:
a cladding structure extending along a fiber length providing a hollow interior fiber region;
a first anti-resonant (AR) element and a second AR element distributed within the hollow interior fiber region, wherein the first AR element is located within an interior region of the second AR element bounded at least in part by walls of the second AR element; and
a support structure located in the hollow interior fiber region, wherein:
the second AR element is positioned on an interior surface of the cladding structure such that a portion of the walls of the second AR element contacts the interior surface of the cladding structure,
the support structure is positioned on the portion of the walls of the second AR element that contacts the interior surface of the cladding structure,
the first AR element is positioned on the walls of the second AR element via the support structure, and
the first AR element is rotated in the hollow interior fiber region such that a first center line connecting the support structure and a center point of the first AR element is offset by a non-zero angle relative to a second center line connecting the support structure and a center point of the hollow interior fiber region.

12. The optical fiber of claim 11, wherein at least one of the first AR element or the second AR element is configured to guide light along the fiber length in a central portion of the hollow interior fiber region based on optical anti-resonance.

13. The optical fiber of claim 11, wherein a width or diameter of the second AR element is greater than a width or diameter of the first AR element.

14. The optical fiber of claim 11, wherein a thickness of the walls of the second AR element is different from a thickness of walls of the first AR element.

15. The optical fiber of claim 11, wherein at least one of the first AR element or the second AR element has a cross-sectional shape as one of: a circle, an ellipse, a truncated circle, a truncated ellipse, a triangle, a square, a pentagon, a hexagon, a heptagon, or an octagon.

16. The optical fiber of claim 11, wherein the non-zero angle is in a range of 1 to 15 degrees.

17. A method for making an optical fiber comprising:
providing a cladding structure extending along a fiber length providing a hollow interior fiber region;
providing a first anti-resonant (AR) element distributed within the hollow interior fiber region; and
providing a support structure located in the hollow interior fiber region, wherein:
the first AR element is disposed on an interior surface of the cladding structure via the support structure, and
the first AR element is rotated in the hollow interior fiber region such that a first center line connecting the support structure and a center point of the first AR element is offset by a non-zero angle relative to a second center line connecting the support structure and a center point of the hollow interior fiber region.

18. The method of claim 17, wherein the non-zero angle is between 1 to 15 degrees.

19. The method of claim 17, further comprising providing a second AR element disposed inside the first AR element.

20. The method of claim 19, wherein the first AR element or second AR element has a cross-sectional shape as one of: a circle, an ellipse, a truncated circle, a truncated ellipse, a triangle, a square, a pentagon, a hexagon, a heptagon, or an octagon.
